(19) United States
(12) Patent Application Publication
(10) Pub. No.: US 2026/0311161 A1
(43) Pub. Date: Oct. 8, 2026

(54) System and Method for Identity-Linked Social Communication Initiation Using Activation Assets

(71) Applicant: TapText llc, Coral Springs, FL (US)

(72) Inventors: Steve Doumar, Fort Lauderdale, FL (US); Brian Galvin, Silverdale, WA (US)

(21) Appl. No.: 19/714,822

(22) Filed: Jun. 22, 2026

Related U.S. Application Data
(63) Continuation-in-part of application No. 19/696,642, filed on Jun. 3, 2026.
Application No. 19/696,642 is a continuation-in-part of application No. 19/683,929, filed on May 21, 2026.
Application No. 19/683,929 is a continuation-in-part of application No. 19/441,824, filed on Jan. 6, 2026.
Application No. 19/441,824 is a continuation of application No. 17/874,209, filed on Jul. 26, 2022, now Pat. No. 12,519,888.
Application No. 17/874,209 is a continuation-in-part of application No. 17/865,814, filed on Jul. 15, 2022, now Pat. No. 12,211,070.
Application No. 17/865,814 is a continuation-in-part of application No. 17/229,251, filed on Apr. 13, 2021, now abandoned.
Application No. 17/229,251 is a continuation-in-part of application No. 17/209,474, filed on Mar. 23, 2021, now Pat. No. 11,599,916.
Application No. 19/696,642 is a continuation-in-part of application No. 18/631,042, filed on Apr. 10, 2024, now Pat. No. 12,657,570.
Application No. 18/631,042 is a continuation-in-part of application No. 18/593,911, filed on Mar. 3, 2024, now Pat. No. 12,182,794.
Application No. 18/593,911 is a continuation-in-part of application No. 18/185,993, filed on Mar. 17, 2023, now Pat. No. 11,995,639.
Application No. 18/185,993 is a continuation of application No. 17/409,841, filed on Aug. 24, 2021, now Pat. No. 11,610,193.
Application No. 17/409,841 is a continuation-in-part of application No. 17/360,731, filed on Jun. 28, 2021, now Pat. No. 11,871,308.
Application No. 17/360,731 is a continuation-in-part of application No. 17/229,251, filed on Apr. 13, 2021, now abandoned.
Application No. 17/229,251 is a continuation-in-part of application No. 17/085,931, filed on Oct. 30, 2020, now Pat. No. 11,055,736.
(63) Continuation-in-part of application No. 18/952,899, filed on Nov. 19, 2024.
Application No. 18/952,899 is a continuation of application No. 18/365,953, filed on Aug. 4, 2023, now Pat. No. 12,147,996.
Application No. 18/365,953 is a continuation of application No. 17/967,606, filed on Oct. 17, 2022, now Pat. No. 12,293,379.
Application No. 17/967,606 is a continuation-in-part of application No. 17/879,605, filed on Aug. 2, 2022, now Pat. No. 11,657,424.
Application No. 17/879,605 is a continuation-in-part of application No. 17/209,474, filed on Mar. 23, 2021, now Pat. No. 11,599,916.
Application No. 17/209,474 is a continuation-in-part of application No. 17/208,059, filed on Mar. 22, 2021, now Pat. No. 11,562,407.
Application No. 17/208,059 is a continuation-in-part of application No. 17/191,977, filed on Mar. 4, 2021, now abandoned.
Application No. 17/191,977 is a continuation-in-part of application No. 17/190,260, filed on Mar. 2, 2021, now Pat. No. 11,532,020.
Application No. 17/190,260 is a continuation-in-part of application No. 17/153,426, filed on Jan. 20, 2021, now abandoned.
Application No. 17/879,605 is a continuation-in-part of application No. 16/930,816, filed on Jul. 16, 2020, now Pat. No. 11,403,666.
Application No. 16/930,816 is a continuation-in-part of application No. 16/693,275, filed on Nov. 23, 2019, now Pat. No. 11,270,354.
Application No. 17/967,606 is a continuation-in-part of application No. 17/351,321, filed on Jun. 18, 2021, now Pat. No. 11,201,965.
Application No. 17/351,321 is a continuation of application No. 17/349,659, filed on Jun. 16, 2021, now Pat. No. 11,488,188.
Application No. 17/349,659 is a continuation of application No. 17/348,660, filed on Jun. 15, 2021, now Pat. No. 11,232,471.
Application No. 17/348,660 is a continuation of application No. 17/344,695, filed on Jun. 10, 2021, now Pat. No. 11,354,691.
Application No. 17/344,695 is a continuation of application No. 17/229,251, filed on Apr. 13, 2021, now abandoned.
Application No. 17/229,251 is a continuation-in-part of application No. 17/209,474, filed on Mar. 23, 2021, now Pat. No. 11,599,916.
(60) Provisional application No. 62/879,862, filed on Jul. 29, 2019.
(60) Provisional application No. 62/883,360, filed on Aug. 6, 2019.
(60) Provisional application No. 62/904,568, filed on Sep. 23, 2019.
(60) Provisional application No. 62/940,607, filed on Nov. 26, 2019.
(60) Provisional application No. 62/963,368, filed on Jan. 20, 2020.
(60) Provisional application No. 62/963,379, filed on Jan. 20, 2020.
(60) Provisional application No. 62/963,368, filed on Jan. 20, 2020.
(60) Provisional application No. 62/963,379, filed on Jan. 20, 2020.
(60) Provisional application No. 62/963,568, filed on Jan. 21, 2020.
(60) Provisional application No. 62/965,626, filed on Jan. 24, 2020.
(60) Provisional application No. 62/965,626, filed on Jan. 24, 2020.
(60) Provisional application No. 62/994,219, filed on Mar. 24, 2020.
(60) Provisional application No. 62/994,219, filed on Mar. 24, 2020.
(60) Provisional application No. 63/022,190, filed on May 8, 2020.
(60) Provisional application No. 63/022,190, filed on May 8, 2020.
(60) Provisional application No. 63/025,287, filed on May 15, 2020.
(60) Provisional application No. 63/025,287, filed on May 15, 2020.
(60) Provisional application No. 63/040,610, filed on Jun. 18, 2020.
(60) Provisional application No. 63/040,610, filed on Jun. 18, 2020.
(60) Provisional application No. 63/154,357, filed on Feb. 26, 2021.
(60) Provisional application No. 63/166,391, filed on Mar. 26, 2021.
(60) Provisional application No. 63/166,391, filed on Mar. 26, 2021.
(60) Provisional application No. 63/211,496, filed on Jun. 16, 2021.
(60) Provisional application No. 63/235,785, filed on Aug. 22, 2021.
(60) Provisional application No. 63/519,559, filed on Aug. 14, 2023.

(51) Int. Cl. G06Q 20/32; G06Q 20/40; H04W 4/80

(52) U.S. Cl. CPC G06Q 20/3276; G06Q 20/4014; H04W 4/80

(57) ABSTRACT

is disclosed. A digital activation asset associated with a destination-user identity profile enables an initiating user to request communication through privacy-controlled pathways. Upon activation, an interaction control server resolves the destination identity, retrieves permission states and contextual provenance, determines channel eligibility across multiple protocols, and constructs capability-aware introduction messages adapted to available communication modes. The system supports masked relay, approval-required flows, and AI-assisted mediation including safety screening, message enhancement, and response suggestion. A persistent identity management service anchored to phone numbers accumulates interaction history, protocol preferences, and relationship-state data across sessions. Session continuity mechanisms preserve thread identity during protocol fallback from enhanced formats to constrained alternatives. Contextual provenance from events, venues, or media sources enriches first-contact communications and informs trust scoring, enabling progressive relationship maturation from initial masked introduction through optional direct contact disclosure.

### CROSS-REFERENCE TO RELATED APPLICATIONS

Priority is claimed in the application data sheet to the following patents or patent applications, each of which is expressly incorporated herein by reference in its entirety:
Ser. No. 19/696,642
Ser. No. 19/683,929
Ser. No. 19/441,824
Ser. No. 17/874,209
Ser. No. 17/865,814
Ser. No. 17/229,251
63/166,391
Ser. No. 17/209,474
Ser. No. 17/208,059
Ser. No. 17/191,977
Ser. No. 17/190,260
Ser. No. 17/153,426
63/154,357
Ser. No. 18/631,042
Ser. No. 18/593,911
63/519,562
Ser. No. 18/185,993
Ser. No. 17/409,841
Ser. No. 17/360,731
Ser. No. 17/085,931
63/211,496
63/519,559
Ser. No. 18/952,899
Ser. No. 18/365,953
Ser. No. 17/967,606
Ser. No. 17/879,605
63/235,785
Ser. No. 16/930,816
Ser. No. 17/351,321
Ser. No. 17/349,659
Ser. No. 17/348,660
Ser. No. 17/344,695

### BACKGROUND OF THE INVENTION

### Field of the Art

The present invention relates to the field computer-based communication systems, and more specifically to systems and methods for identity-linked social communications.

### Discussion of the State of the Art

Existing mechanisms for socially oriented first contact are generally crude, fragmented, and context-poor. In many common scenarios, a first user who wishes to contact a second user must obtain and manually enter the second user's phone number, exchange social-media handles, scan a code that merely opens a generic message composition screen, or use an app-specific friend request flow that requires both users to participate in the same application ecosystem. These conventional techniques are operationally simple, but they fail to provide the technical safeguards, persistence mechanisms, and contextual intelligence needed for robust, privacy-aware, and friction-reducing communication initiation. Direct disclosure of a destination phone number often forces the destination user to reveal persistent contact information before the destination user has had an opportunity to evaluate the initiating user or the context of the attempted communication. Similarly, conventional QR-code-based or hyperlink-based communication flows typically function only as static shortcuts. They may prepopulate a text message or direct a user to a webpage, but they do not intelligently determine whether the communication should be relayed, masked, delayed, reformatted, approved, denied, or routed through an alternative protocol. Nor do such systems generally preserve rich contextual information concerning where the two users met, how the interaction was initiated, what permissions apply to the interaction, or how future communications should be optimized.

Prior communication-routing and campaign-interaction systems have addressed certain aspects of communication initiation, omnichannel routing, masking, and analytics in business-to-customer contexts. However, those systems are generally organized around business endpoints, campaign endpoints, product or service funnels, or enterprise routing objectives. A socially initiated communication problem is materially different. In the social-initiation setting, the destination is not merely a business representative, a support queue, or a campaign-associated endpoint. Instead, the destination is a person-centric identity node having individual privacy expectations, communication preferences, approval policies, contextual history, and relationship-dependent permissions. Existing business-oriented systems do not adequately provide for user-specific first-contact approval, person-centric privacy release rules, social-context preservation, relationship-state formation, or machine-managed progression from an initial introduction to a persistent interaction state.

Modern messaging systems commonly treat each contact event as either an isolated message exchange or a platform-native conversation, rather than as an interaction involving a persistent, protocol-aware, and context-enriched identity record. Conventional systems generally do not maintain a persistent identity profile anchored to a stable identifier such as a phone number and enriched by interaction history, protocol history, device associations, permission state, venue or event provenance, inferred communication preferences, and Artificial Intelligence (AI)-derived response or trust indicators. As a result, such systems cannot automatically optimize future communications based on accumulated intelligence. Current messaging systems also do not generally combine consent-state evaluation, real-time protocol-eligibility determination, device and carrier capability assessment, and capability-aware message construction in the context of socially initiated communications. Enhanced protocols such as Rich Communication Service (RCS) may be available in some cases, but existing systems typically do not conditionally select such protocols based on a combination of social-contact permissions, technical feasibility, and context-aware rendering requirements, nor do they generally preserve session continuity if an enhanced protocol fails and a fallback protocol must be used.

What is needed is a system and method for identity-linked social communication initiation using activation assets, in which a first user may initiate communication toward a second user by activating a digital asset associated with the second user's persistent identity profile, and in which the resulting communication is governed by privacy-aware permissions, contextual provenance, protocol eligibility, capability-aware rendering, and optional artificial-intelligence-assisted mediation. What is further needed is such a system in which phone numbers or other stable identifiers serve as persistent identity anchors, enabling accumulation of contextual intelligence across multiple sessions and interaction contexts; in which a first-contact request may be relayed, masked, approved, reformatted, delayed, or denied according to user-specific policies; in which the system can dynamically select among multiple protocols and messaging channels based on consent state and technical capability; and in which the resulting relationship state can persist beyond the initial communication event, thereby allowing frictionless continuation of communications over time without repeated manual re-establishment of context or preferences.

### SUMMARY OF THE INVENTION

According to a preferred embodiment, a system for identity-linked social communication initiation using activation assets, the system comprising: a digital activation asset associated with a destination-user identity profile, the digital activation asset comprising a machine-readable or machine-activatable object configured to be activated by an initiating user device; an interaction control server communicatively coupled to the initiating user device and configured to: receive an interaction event resulting from activation of the digital activation asset by the initiating user device, the interaction event comprising at least a destination-user identifier and contextual metadata; resolve the destination-user identifier to the destination-user identity profile, the destination-user identity profile being anchored to a phone number and comprising at least a permission state, interaction history, and relationship-state data; evaluate the permission state to determine whether communication is permitted and to determine a communication mode selected from a set comprising direct communication, masked relay, and approval-required communication; determine channel eligibility by evaluating at least device capability, carrier support for multiple communication protocols, and historical protocol success for the destination user; construct a capability-aware first-contact message adapted to a selected communication protocol and the determined communication mode; and deliver the capability-aware first-contact message to a destination user device associated with the destination-user identity profile; wherein the interaction control server is further configured to create or update a relationship-state object linking the initiating user and the destination user when communication is established, the relationship-state object storing at least first-contact provenance, approval state, communication preferences, and protocol transition history.

According to another preferred embodiment, a method for identity-linked social communication initiation using activation assets, the method comprising the steps of: receiving an interaction event resulting from activation of the digital activation asset by the initiating user device, the interaction event comprising at least a destination-user identifier and contextual metadata, using an interaction control server; resolving the destination-user identifier to the destination-user identity profile, the destination-user identity profile being anchored to a phone number and comprising at least a permission state, interaction history, and relationship-state data, using an interaction control server; evaluating the permission state to determine whether communication is permitted and to determine a communication mode selected from a set comprising direct communication, masked relay, and approval-required communication, using an interaction control server; determining channel eligibility by evaluating at least device capability, carrier support for multiple communication protocols, and historical protocol success for the destination user, using an interaction control server; constructing a capability-aware first-contact message adapted to a selected communication protocol and the determined communication mode, using an interaction control server; delivering the capability-aware first-contact message to a destination user device associated with the destination-user identity profile, using an interaction control server; creating or updating a relationship-state object linking the initiating user and the destination user when communication is established, the relationship-state object storing at least first-contact provenance, approval state, communication preferences, and protocol transition history, using an interaction control server.

### BRIEF DESCRIPTION OF THE DRAWING FIGURES

FIG. 1 is a system diagram illustrating an exemplary architecture for an identity-linked social communication initiation platform using activation assets.

FIG. 2 is a system diagram illustrating communication flow among an initiating user device, a destination-user identity profile, an activation asset, an interaction control server, and a messaging gateway in the context of identity-linked social communication initiation.

FIG. 3 is a method diagram illustrating activation of a digital activation asset and initiation of a first-contact communication event.

FIG. 4 is a method diagram illustrating privacy-controlled masked relay of first contact between an initiating user and a destination user.

FIG. 5 is a block diagram illustrating a persistent identity profile structure for a destination user.

FIG. 6 is a state diagram illustrating multi-state permissions governing socially initiated communications.

FIG. 7 is a method diagram illustrating channel-eligibility determination for social-contact initiation across multiple protocols.

FIG. 8 is a sequence diagram illustrating capability negotiation and protocol selection for a first-contact message.

FIG. 9 is a flowchart illustrating capability-aware message construction for enhanced and fallback protocols.

FIG. 10 is a method diagram illustrating an approval-required or mutual-consent communication initiation flow.

FIG. 11 is a method diagram illustrating artificial-intelligence-assisted safety screening, message enhancement, response suggestion, and contact prioritization.

FIG. 12 is a method diagram illustrating session continuity and protocol fallback during an ongoing socially initiated communication.

FIG. 13 is a data-flow diagram illustrating relationship-state persistence across multiple sessions, contexts, and communication channels.

FIG. 14 is a system diagram illustrating venue-bound, event-bound, or media-bound activation assets and contextual provenance capture.

FIG. 15 is a block diagram illustrating downstream integrations including analytics, moderation, customer relationship management, loyalty, safety services, and social graph services.

FIG. 16 illustrates an exemplary computing environment on which an embodiment described herein may be implemented.

### DETAILED DESCRIPTION OF THE INVENTION

The inventor has conceived and reduced to practice a system and method for identity-linked social communication initiation using activation assets. In preferred embodiments, the invention enables a first user to initiate communication toward a second user through activation of a digital activation asset that is associated with a persistent destination-user identity profile rather than merely with a static phone number, hyperlink destination, or generic application endpoint. The disclosed system differs from conventional contact-initiation tools in that it treats the communication opportunity itself as a managed and policy-aware interaction event. Rather than merely exposing raw contact information or opening an unmanaged communication interface, the system resolves the destination-user identity, retrieves contextual and permission data associated with that identity, determines whether and how communication is permitted, selects an appropriate communication mode or protocol, and then facilitates the resulting interaction in a manner that may preserve privacy, context, continuity, and future optimization capability.

In preferred embodiments, the digital activation asset is associated with a destination-user identity profile that is persistently maintained by the platform. The identity profile may be anchored to a phone number and may further include device associations, protocol preferences, interaction history, social-context history, permission state, venue or event provenance, inferred user preferences, response behavior, safety settings, and relationship-state objects. Accordingly, when a first user activates the activation asset, the system is able to process the resulting interaction not as an isolated event but as part of an identity-linked and potentially long-lived communication framework. A first-contact interaction may be initiated in any of a wide variety of contexts including conferences, nightlife venues, campus environments, residential communities, alumni gatherings, fan experiences, and other relationship-forming environments. The initiating user may scan, tap, click, invoke, or otherwise activate the asset using a user device, causing the system to receive an interaction event that may include a destination-user identifier, an asset identifier, contextual metadata, timing data, device data, and other information associated with the initiation event.

In preferred embodiments, the resulting communication is not necessarily direct. Instead, the interaction control server may determine that the communication should be handled through a masked relay channel, through a pending approval workflow, through a protocol-specific introduction card, through a deferred or scheduled communication, or through another controlled pathway. The system may determine such pathway based on one or more of destination-user permissions, initiating-user characteristics, prior interaction history, current device or carrier capability, environmental context, trust score, AI-derived risk analysis, event or venue provenance, relationship-state conditions, or administrative policy. The disclosed system also permits a socially initiated interaction to evolve over time. If the first-contact attempt is approved or otherwise progresses, the platform may create or update a persistent relationship-state object linking the initiating user and the destination user. This relationship-state object may store information including first-contact provenance, approval state, communication preferences specific to the pair of users, protocol-transition history, trust indicators, privacy-release state, moderation flags, and follow-up or scheduling information. In this manner, the invention supports not only first-contact initiation but also continuity and progressive optimization of later communications.

The disclosed platform further incorporates artificial-intelligence-assisted mediation to improve safety, quality, and relevance of socially initiated communications. An AI mediation engine may perform safety screening to detect spam, abuse, fraud, or policy violations, may generate trust scores based on contextual factors and user history, may enhance message content to improve clarity and social appropriateness, may infer relationship categories to inform message framing and response options, and may generate suggested responses to reduce friction for destination users. The platform may also optimize delivery timing based on destination-user activity patterns and preferences, and may prioritize first-contact requests based on trust scores and contextual relevance, ensuring that destination users see the most valuable networking opportunities first.

In preferred embodiments, the system supports capability-aware message construction that adapts first-contact communications to the selected protocol and associated capability constraints. When an enhanced protocol such as RCS is available and permitted, the system constructs rich introduction cards with structured identity information, interactive buttons, contextual provenance, branded sender indicators, and media content. When a constrained protocol such as SMS or MMS must be used, the system constructs plain text messages with numbered reply options and text-based context descriptions that preserve the same interaction intent in a simplified format. The system further provides session continuity mechanisms that preserve thread identity when delivery through an initially selected protocol fails and the message must be regenerated for a fallback protocol, ensuring that communications can proceed reliably across heterogeneous device and network environments without loss of context or attribution.

One or more different aspects may be described in the present application. Further, for one or more of the aspects described herein, numerous alternative arrangements may be described; it should be appreciated that these are presented for illustrative purposes only and are not limiting of the aspects contained herein or the claims presented herein in any way. One or more of the arrangements may be widely applicable to numerous aspects, as may be readily apparent from the disclosure. In general, arrangements are described in sufficient detail to enable those skilled in the art to practice one or more of the aspects, and it should be appreciated that other arrangements may be utilized and that structural, logical, software, electrical and other changes may be made without departing from the scope of the particular aspects. Particular features of one or more of the aspects described herein may be described with reference to one or more particular aspects or figures that form a part of the present disclosure, and in which are shown, by way of illustration, specific arrangements of one or more of the aspects. It should be appreciated, however, that such features are not limited to usage in the one or more particular aspects or figures with reference to which they are described. The present disclosure is neither a literal description of all arrangements of one or more of the aspects nor a listing of features of one or more of the aspects that must be present in all arrangements.

Headings of sections provided in this patent application and the title of this patent application are for convenience only, and are not to be taken as limiting the disclosure in any way.

Devices that are in communication with each other need not be in continuous communication with each other, unless expressly specified otherwise. In addition, devices that are in communication with each other may communicate directly or indirectly through one or more communication means or intermediaries, logical or physical.

A description of an aspect with several components in communication with each other does not imply that all such components are required. To the contrary, a variety of optional components may be described to illustrate a wide variety of possible aspects and in order to more fully illustrate one or more aspects. Similarly, although process steps, method steps, algorithms or the like may be described in a sequential order, such processes, methods and algorithms may generally be configured to work in alternate orders, unless specifically stated to the contrary. In other words, any sequence or order of steps that may be described in this patent application does not, in and of itself, indicate a requirement that the steps be performed in that order. The steps of described processes may be performed in any order practical. Further, some steps may be performed simultaneously despite being described or implied as occurring non-simultaneously (e.g., because one step is described after the other step). Moreover, the illustration of a process by its depiction in a drawing does not imply that the illustrated process is exclusive of other variations and modifications thereto, does not imply that the illustrated process or any of its steps are necessary to one or more of the aspects, and does not imply that the illustrated process is preferred. Also, steps are generally described once per aspect, but this does not mean they must occur once, or that they may only occur once each time a process, method, or algorithm is carried out or executed. Some steps may be omitted in some aspects or some occurrences, or some steps may be executed more than once in a given aspect or occurrence.

When a single device or article is described herein, it will be readily apparent that more than one device or article may be used in place of a single device or article. Similarly, where more than one device or article is described herein, it will be readily apparent that a single device or article may be used in place of the more than one device or article.

The functionality or the features of a device may be alternatively embodied by one or more other devices that are not explicitly described as having such functionality or features. Thus, other aspects need not include the device itself.

Techniques and mechanisms described or referenced herein will sometimes be described in singular form for clarity. However, it should be appreciated that particular aspects may include multiple iterations of a technique or multiple instantiations of a mechanism unless noted otherwise. Process descriptions or blocks in figures should be understood as representing modules, segments, or portions of code which include one or more executable instructions for implementing specific logical functions or steps in the process. Alternate implementations are included within the scope of various aspects in which, for example, functions may be executed out of order from that shown or discussed, including substantially concurrently or in reverse order, depending on the functionality involved, as would be understood by those having ordinary skill in the art.

### Conceptual Architecture

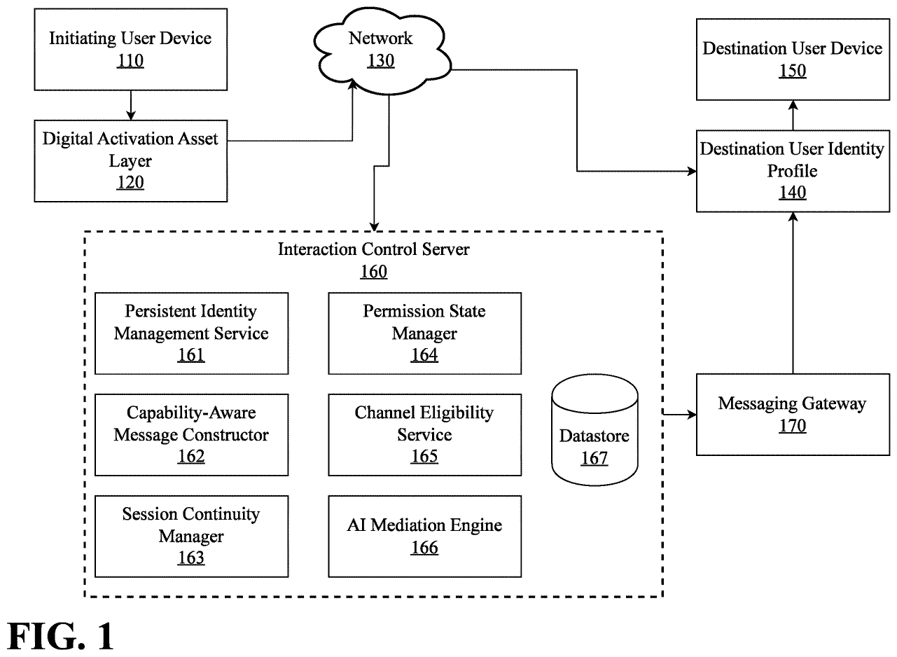

FIG. 1 is a system diagram illustrating an exemplary architecture for an identity-linked social communication initiation platform using activation assets. The system comprises one or more user devices, a digital activation asset layer, a messaging gateway, an interaction control server, one or more data stores, and a network enabling communication among these components.

An initiating user device 110 is associated with an initiating user who activates a digital activation asset to initiate communication toward a destination user. A destination user device 150 is associated with a destination user who receives communications mediated through the platform. Both the initiating user device 110 and the destination user device 150 may comprise smartphones, tablets, laptops, desktop computers, wearable devices, or other computing devices capable of transmitting, receiving, displaying, or interacting with digital communications. These devices communicate through network 130, which may comprise cellular networks, data networks, packet-switched networks, internet-based communication systems, or combinations thereof.

A digital activation asset layer 120 provides one or more activation assets associated with destination users. Each activation asset may comprise a QR code, redirect URL, near-field communication token, image marker, machine-readable graphic, or other digital or machine-activatable object that can be used to trigger an interaction with the platform. The digital activation asset layer 120 is linked to a destination user identity profile 140, which is a persistent identity record anchored to a stable identifier such as a phone number and maintained by the platform. The destination user identity profile 140 may store accumulated interaction history, device associations, protocol usage patterns, permission-state transitions, event or venue associations, timing preferences, inferred behavioral preferences, moderation history, and relationship-state information.

The interaction control server 160 is configured to receive interaction events resulting from activation of digital activation assets, resolve destination-user identities, retrieve permissions and contextual information, determine channel eligibility, construct communications adapted to the selected protocol, maintain session continuity, and facilitate socially initiated communications under privacy and policy controls. The interaction control server 160 comprises one or more logical services or subsystems, whether integrated or distributed, including a persistent identity management service 161, a capability-aware message constructor 162, a session continuity manager 163, a permission state manager 164, a channel eligibility service 165, and an AI mediation engine 166.

The persistent identity management service 161 maintains destination-user identity profiles and, in some embodiments, initiating-user identity profiles, each anchored to a stable identifier such as a phone number. The capability-aware message constructor 162 constructs first-contact communication artifacts according to the selected protocol and associated capability profile, generating structured social introduction cards for enhanced protocols or rendering substantially the same interaction intent in text form for fallback protocols. The session continuity manager 163 assigns session identifiers to socially initiated interactions and preserves those identifiers across multiple message exchanges and protocol transitions. The permission state manager 164 maintains one or more permission states governing whether, and in what manner, socially initiated communications are permitted. The channel eligibility service 165 evaluates whether a socially initiated communication should be delivered through one protocol or another based on permission state, device capability, carrier support, current protocol reachability, historical delivery success, destination-user preferences, and contextual constraints. The AI mediation engine 166 may optionally perform safety screening, message filtering, language normalization, social appropriateness analysis, fraud or spam detection, response suggestion, timing optimization, trust inference, and prioritization of incoming contact attempts.

A datastore 167 stores activation asset definitions, destination-user identity profiles, initiating-user identity profiles, permission states, capability records, interaction histories, session records, relationship-state objects, event or venue mappings, AI-derived inferences, and downstream integration payloads. The datastore 167 may be centralized, distributed, replicated, federated, document-oriented, relational, graph-oriented, vector-based, or otherwise structured according to implementation requirements.

A messaging gateway 170 is communicatively coupled to the user devices and to the interaction control server 160. The messaging gateway 170 supports a plurality of communication protocols and may send and receive communications across one or more networks including cellular networks, data networks, packet-switched networks, internet-based communication systems, and future messaging infrastructures. The messaging gateway 170 may comprise protocol-specific modules or interfaces for SMS, MMS, RCS, email, web chat, app-based messaging, or other communications modalities. In some embodiments, the messaging gateway 170 further comprises one or more capability-negotiation interfaces configured to communicate with external messaging platforms, carrier services, or verification services in order to determine protocol availability, feature support, sender verification state, or fallback requirements.

In operation, a destination user exposes or causes exposure of one or more activation assets associated with that destination user's identity-linked communication profile through the digital activation asset layer 120. An initiating user activates one of the assets using the initiating user device 110. The resulting interaction event is received by the interaction control server 160, either directly or through the messaging gateway 170. The interaction control server 160 resolves the destination identity using the destination user identity profile 140, retrieves permissions and context, determines whether communication is allowed, selects a communication mode, constructs an introduction or other communication artifact, and delivers or relays that communication in accordance with the governing rules and capabilities of the system. If the communication progresses, the interaction control server 160 may create or update a persistent relationship-state object stored in the datastore 167, thereby enabling subsequent interactions to benefit from accumulated context and identity-linked optimization rather than beginning anew as isolated events.

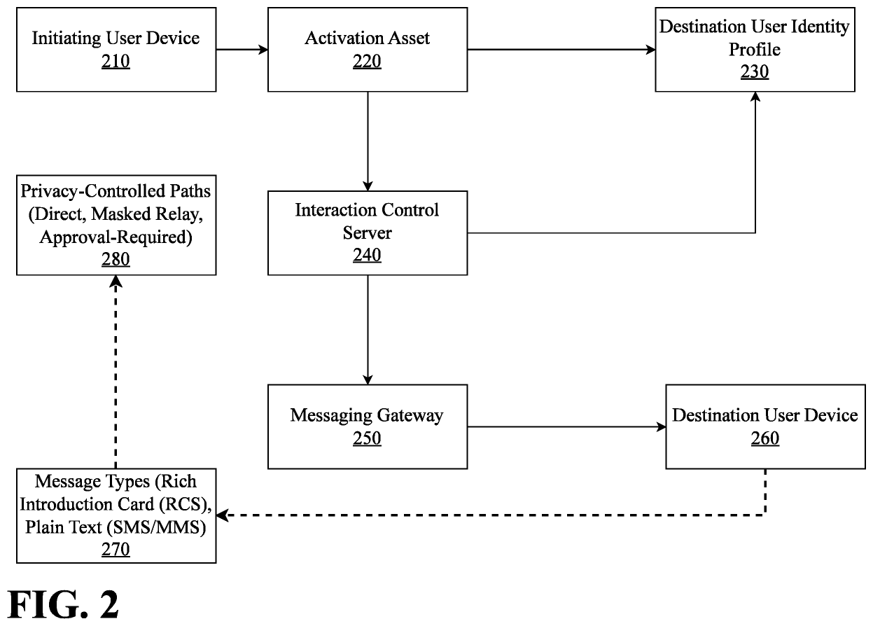

FIG. 2 is a system diagram illustrating communication flow among an initiating user device, a destination-user identity profile, an activation asset, an interaction control server, and a messaging gateway in the context of identity-linked social communication initiation. The diagram emphasizes the distinct roles of initiating user versus destination user and shows privacy-controlled routing paths including direct, masked relay, and approval-required modes. This figure demonstrates how the platform mediates first-contact communications between users while preserving privacy, contextual provenance, and protocol adaptability.

An initiating user device 210 is associated with an initiating user who wishes to establish communication with a destination user. The initiating user device 210 may comprise a smartphone, tablet, laptop computer, desktop computer, wearable device, kiosk interface, vehicle interface, or other computing device capable of transmitting, receiving, displaying, or interacting with digital communications. The initiating user device 210 supports one or more methods of asset activation including scanning QR codes, tapping near-field communication tokens, clicking redirect links, pressing graphical buttons, or invoking app-integrated controls.

The initiating user device 210 interacts with an activation asset 220, which may comprise a QR code, NFC token, redirect link, visual marker, machine-readable graphic, graphical button, account-linked visual token, event badge code, wearable token, temporary invitation code, or other digital or machine-activatable object associated with a destination user. The activation asset 220 is not merely a static pointer to a destination phone number, but instead is linked to a platform-managed destination-user identity profile that enables the system to resolve identity, retrieve applicable permissions and context, and determine an appropriate communication treatment based on policy, capability, and accumulated intelligence. The activation asset 220 may be static, semi-static, dynamic, temporary, expiring, rotating, revocable, context-bound, or user-configurable, and may be presented through physical media such as printed cards or badges, digital media such as mobile-device screens or social profiles, or hybrid embodiments combining printed assets with dynamically associated digital identity records.

The activation asset 220 is linked to a destination user identity profile 230, which is a persistent identity record maintained by the platform and anchored to a stable identifier such as a phone number. The destination user identity profile 230 stores accumulated interaction history including prior communication attempts, approval or rejection events, trust scores, and moderation flags. The profile further stores device associations indicating which devices are linked to the destination user's identity, protocol usage patterns reflecting historical success rates and preferences for different communication modes, permission-state transitions documenting when and how the destination user's privacy settings have changed, and event or venue associations recording contexts in which the destination user's activation assets have been deployed or activated. Additionally, the destination user identity profile 230 maintains timing preferences such as preferred hours for receiving communications or deferment policies, inferred behavioral preferences derived from AI analysis of past interactions, moderation history including safety events and policy violations, and relationship-state information linking the destination user to initiating users with whom prior interactions have occurred.

When the initiating user device 210 activates the activation asset 220, an interaction event is transmitted to an interaction control server 240. This interaction event may comprise an asset identifier, a destination-user identifier, contextual metadata such as time and location, device data identifying the type and capabilities of the initiating user device 210, and in some embodiments, initiating-user-provided introduction text or self-identification information. The interaction control server 240 receives this interaction event either directly from the initiating user device 210 or through intermediary systems such as web servers, application servers, or API gateways.

The interaction control server 240 resolves the destination user identity profile 230, retrieves applicable permissions and contextual information, determines channel eligibility, and selects an appropriate privacy-controlled communication pathway. The resolution process involves querying a persistent identity management service to obtain the destination user identity profile 230 based on the asset identifier or destination-user identifier received in the interaction event. Once the profile is retrieved, the interaction control server 240 evaluates the current permission state governing socially initiated communications for this destination user, which may indicate whether communications are permitted at all, whether they must proceed through masked relay, whether approval is required before any message is delivered, whether enhanced protocol features are allowed, or whether direct contact disclosure is permitted under certain conditions.

The interaction control server 240 further evaluates contextual information associated with the activation event, including where and when the asset was activated, what type of asset was used, whether the activation occurred within a known event or venue context, and whether any mutual affiliations or shared context can be inferred between the initiating user and destination user. This contextual evaluation may influence trust scoring, prioritization, message framing, and the selection of communication pathways. The interaction control server 240 also determines channel eligibility by evaluating device capability, carrier support for various protocols, historical delivery success rates, destination-user protocol preferences, application availability on both user devices, verification status for branded or enhanced messaging, and any contextual constraints that might favor one protocol over another.

Based on this multi-faceted evaluation, the interaction control server 240 selects one of several privacy-controlled paths 280 through which the communication will proceed. These privacy-controlled paths 280 include direct communication where a message is delivered immediately to the destination user device 260 without requiring approval and without masking endpoint identifiers, masked relay where messages pass between the initiating user and destination user through system-controlled relay addresses or session endpoints such that direct phone numbers or email addresses remain hidden from both parties, and approval-required flows where the destination user receives an approval request rather than the full message content and must affirmatively accept the request before a communication thread is opened or substantive messages are exchanged.

The selection among these privacy-controlled paths 280 depends on the permission state retrieved from the destination user identity profile 230, the trust score assigned to the initiating user or the interaction event, the contextual provenance of the activation, and any policies configured by the destination user, venue operators, event organizers, or system administrators. For example, a destination user may configure their profile to allow direct rich introductions in a professional networking context while requiring approval-only handling for nightlife-originated contacts. Similarly, the system may automatically impose masked relay for first-time contacts from unknown initiating users while permitting direct follow-up messages from initiating users who have previously been accepted and have maintained positive interaction histories.

Once the privacy-controlled path 280 has been selected, the interaction control server 240 constructs a communication artifact adapted to the selected protocol and privacy mode. Message types 270 may include rich introduction cards delivered via RCS, which are structured communication objects containing identity information such as the initiating user's name or pseudonym and avatar, contextual provenance describing where and when the activation occurred, interactive controls such as accept, decline, defer, or reply buttons, branded or verified sender indicators if applicable, images or media content, and trust or safety indicators generated by AI analysis. Alternatively, message types 270 may include plain text messages delivered via SMS or MMS, which contain substantially the same interaction intent rendered in simplified textual form with numbered reply options such as “Reply 1 to Accept, 2 to Decline, 3 to Ask How We Met,” text-based contextual descriptions in place of structured data fields, and concise introductions adapted to character limits and the absence of rich formatting capabilities.

The capability-aware message construction performed by the interaction control server 240 ensures that the semantic and functional intent of the communication is preserved even when the protocol cannot support richer presentation. If the initially selected protocol is an enhanced protocol such as RCS but delivery through that protocol fails due to device unavailability, carrier limitations, or verification issues, the interaction control server 240 may regenerate the message for a fallback protocol while preserving the same session identifier, contextual metadata, and interaction intent. This protocol fallback capability, managed by a session continuity manager within the interaction control server 240, allows the communication to continue without loss of thread identity, attribution, or relationship-state continuity.

The constructed message is delivered to a destination user device 260 through a messaging gateway 250. The destination user device 260 may comprise a smartphone, tablet, laptop computer, desktop computer, wearable device, or other computing device capable of receiving and displaying the communication. The messaging gateway 250 supports multiple communication protocols including SMS, MMS, RCS, app-based messaging, web-based chat, email, and other messaging modalities. The messaging gateway 250 interfaces with external messaging platforms, carrier services, and verification services to determine protocol availability, negotiate capabilities, obtain sender verification credentials, and handle actual message transmission across cellular networks, data networks, or internet-based communication systems.

Depending on the privacy-controlled path 280 selected by the interaction control server 240, the messaging gateway 250 may establish a direct communication channel where messages are sent directly to the destination user's phone number or messaging endpoint, create a masked relay session using system-controlled identifiers such as temporary relay phone numbers or system-managed session endpoints through which messages pass without exposing direct endpoint identifiers, or deliver an approval request that presents the destination user with an approval object containing information about the initiating user, the activation context, and controls for accepting, declining, or deferring the request, while holding substantive message content pending destination user acceptance.

Throughout this process, the interaction control server 240 maintains session continuity by assigning and preserving a session identifier that links together all messages, approvals, denials, protocol transitions, moderation actions, AI suggestions, and follow-up events associated with the initiation attempt. The interaction control server 240 also preserves contextual provenance by storing information about where, when, and how the activation occurred, which activation asset was used, what event or venue context applies, and what mutual affiliations or shared context exist between the users. This preserved provenance enables the system to provide rich, contextually grounded introductions that reduce ambiguity for the destination user and increase the likelihood of successful communication establishment.

If the communication progresses successfully, whether through immediate acceptance in a direct path, through affirmative approval in an approval-required path, or through successful relay-mediated message exchange in a masked relay path, the interaction control server 240 may create or update a persistent relationship-state object stored in association with the destination user identity profile 230. This relationship-state object links the initiating user and destination user, stores first-contact provenance, records the approval state and any subsequent permission transitions, maintains communication preferences specific to the pair of users, logs protocol-transition history showing how the communication has moved across different channels over time, stores trust indicators and moderation flags relevant to the relationship, and tracks privacy-release state indicating whether direct contact information has been disclosed or remains masked.

The relationship-state object enables subsequent interactions between the same pair of users to benefit from accumulated context and identity-linked optimization rather than beginning anew as isolated events. For example, a follow-up communication attempt days or weeks after the initial contact may be recognized by the interaction control server 240 as involving an existing relationship, allowing the system to apply different permission rules, use different message framing, select different protocols based on learned preferences, or bypass certain approval steps that would otherwise be required for unknown first-time contacts. This progressive relationship maturation, supported by the persistent identity framework anchored to stable phone numbers and maintained across sessions, channels, and time periods, distinguishes the disclosed system from conventional contact-initiation mechanisms that treat each interaction as an isolated event without memory or continuity.

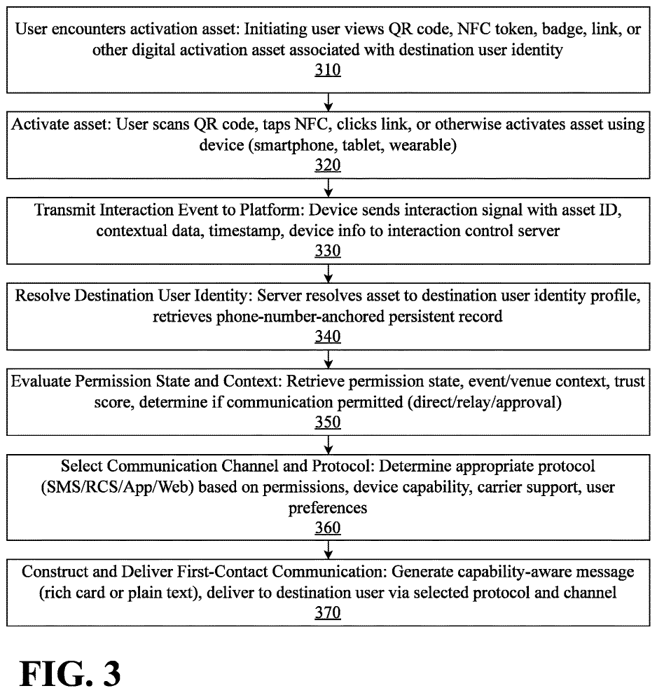

FIG. 3 is a method diagram illustrating activation of a digital activation asset and initiation of a first-contact communication event. The diagram shows the sequence of steps from asset encounter through message delivery, demonstrating how an initiating user's activation of a destination-user-associated asset triggers a platform-mediated communication initiation flow governed by identity resolution, permission evaluation, protocol selection, and capability-aware message construction.

The process begins at step 310, where a user encounters an activation asset. The initiating user views a QR code, NFC token, badge, link, or other digital activation asset associated with a destination user identity. The activation asset may be presented through physical media such as printed cards, event badges, wearable devices, or table markers, or through digital media such as mobile-device screens, social profiles, web pages, or application interfaces. The asset may be deployed in various contexts including conferences, nightlife venues, campus environments, residential communities, alumni gatherings, fan events, or online campaigns.

At step 320, the initiating user activates the asset. The user scans a QR code using a camera-equipped device, taps an NFC token using near-field communication capabilities, clicks a link using a web browser or application, or otherwise activates the asset using a device such as a smartphone, tablet, wearable device, laptop computer, or kiosk interface. The activation may occur through native camera applications, dedicated QR scanning applications, messaging applications with built-in scanning features, web browsers, or platform-specific applications designed to handle activation asset interactions.

At step 330, the device transmits an interaction event to the platform. The device sends an interaction signal containing an asset identifier uniquely identifying the activated asset, contextual data such as geographic location, event identifier, venue identifier, or campaign identifier, a timestamp indicating when the activation occurred, and device information describing the type, capabilities, and configuration of the initiating user device. This interaction event may be transmitted to an interaction control server via cellular networks, Wi-Fi networks, data connections, or other communication pathways. In some embodiments, the interaction event may also include initiating-user-provided information such as a self-introduction message, name, or affiliation.

At step 340, the server resolves the destination user identity. The interaction control server resolves the asset identifier to a destination user identity profile, which is a phone-number-anchored persistent record maintained by the platform. This resolution process involves querying a persistent identity management service using the asset identifier to retrieve the associated destination user identity profile. The profile contains accumulated interaction history, device associations, protocol usage patterns, permission-state transitions, event or venue associations, timing preferences, inferred behavioral preferences, moderation history, and relationship-state information. By anchoring the identity to a stable phone number rather than to ephemeral session identifiers or device-specific tokens, the platform enables accumulation of contextual intelligence across multiple sessions, devices, and interaction contexts over time.

At step 350, the system evaluates permission state and context. The interaction control server retrieves the permission state governing socially initiated communications for the destination user, which may indicate no unsolicited contact permitted, masked relay only, approval-required contact, basic text contact permitted, enhanced protocol contact permitted, verified or branded introduction permitted, direct endpoint disclosure permitted after approval, or direct endpoint disclosure permitted after trust threshold satisfaction. The system also retrieves event or venue context associated with the activation, such as the name and type of the event or venue, the specific location or sub-area within the venue, the time and date of activation, and any mutual affiliations or shared context between the initiating user and destination user. Additionally, the system calculates or retrieves a trust score for the interaction based on factors such as the initiating user's history if available, the context of the activation, the quality of any provided introduction message, and AI-derived safety indicators. Based on this evaluation, the system determines whether communication is permitted and, if so, whether it should proceed through direct delivery, masked relay where endpoint identifiers remain hidden, or approval-required flows where the destination user must affirmatively consent before substantive communication occurs.

At step 360, the system selects a communication channel and protocol. The interaction control server determines the appropriate protocol for delivering the first-contact communication, selecting among SMS, MMS, RCS, app-based messaging, web-based chat, email, or other available communication modes. This selection is based on multiple factors including the permissions retrieved in step 350, the device capabilities of both the initiating user device and the destination user device, carrier support for various protocols as determined through capability negotiation with external messaging platforms, the destination user's historical protocol preferences and success rates, application availability on the destination user device, verification status for branded or enhanced messaging, and contextual constraints such as the type of relationship being initiated or the venue from which the activation occurred. The channel eligibility determination may rank multiple eligible protocols and select a primary protocol with one or more fallback protocols in case delivery through the primary protocol fails.

At step 370, the system constructs and delivers the first-contact communication. The interaction control server generates a capability-aware message adapted to the selected protocol and the applicable permission and privacy constraints. If the selected protocol is an enhanced protocol such as RCS and permissions allow rich introductions, the system constructs a rich introduction card containing structured identity information, the initiating user's name or pseudonym and avatar, contextual provenance describing where and when the activation occurred, interactive buttons such as accept, decline, defer, or reply controls, branded or verified sender indicators if applicable, images or media content, and trust or safety indicators. If the selected protocol is a constrained protocol such as SMS or MMS, or if permissions require a more limited introduction, the system constructs a plain text message containing substantially the same interaction intent rendered in simplified textual form with numbered reply options, text-based contextual descriptions, and concise introductions adapted to character limits. The constructed message is then delivered to the destination user via the selected protocol and channel through a messaging gateway. Throughout this process, the system assigns and maintains a session identifier linking all events associated with this interaction attempt, enabling session continuity if protocol fallback becomes necessary or if the interaction progresses to ongoing communication. If the communication is successfully delivered and, where applicable, accepted by the destination user, the system may create or update a relationship-state object linking the initiating user and destination user, thereby enabling future communications to benefit from accumulated context and optimized handling based on the established relationship.

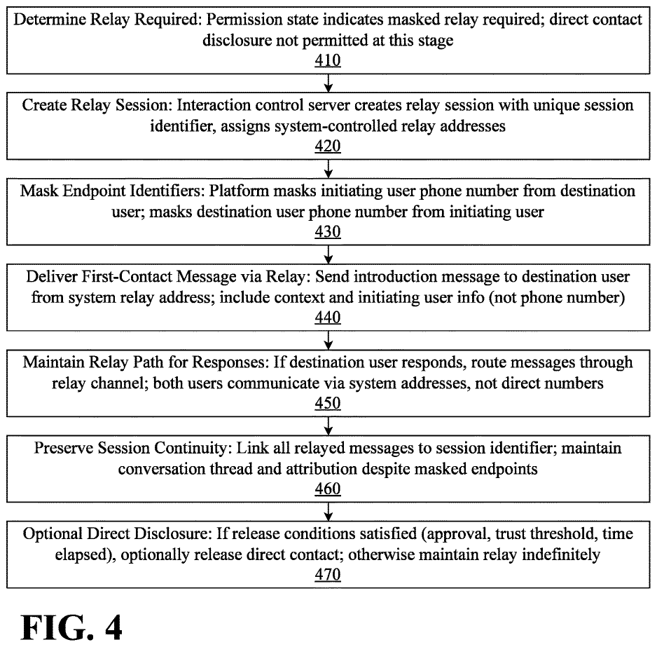

FIG. 4 is a method diagram illustrating privacy-controlled masked relay of first contact between an initiating user and a destination user. The diagram shows the sequence of steps through which the system establishes a relay-mediated communication channel that preserves privacy by preventing premature disclosure of direct contact information while still enabling substantive conversation between users.

The process begins at step 410, where the system determines that relay is required. The permission state retrieved from the destination user identity profile indicates that masked relay is required for socially initiated communications, meaning that direct contact disclosure is not permitted at this stage. This permission state may have been configured by the destination user to protect privacy in certain contexts such as nightlife venues, or may be automatically applied by the system based on trust scoring, the nature of the activation context, or the absence of prior relationship history between the initiating user and destination user. The determination that relay is required may also be influenced by venue-specific policies, event-specific rules, or administrative settings that govern how communications are handled in particular social environments.

At step 420, the interaction control server creates a relay session. The server establishes a relay session with a unique session identifier that will link all messages, events, and state changes associated with this communication thread. The server assigns system-controlled relay addresses, which may comprise temporary relay phone numbers, system-managed email addresses, app-based relay endpoints, or web-based session identifiers through which messages will pass. These relay addresses are drawn from a pool of available system resources and are dynamically allocated for the duration of the relay session. The relay session record stores metadata including the initiating user identifier, destination user identifier, session creation timestamp, context of the original activation, applicable permission states, and the mapping between the actual user endpoints and the assigned relay addresses.

At step 430, the platform masks endpoint identifiers. The system masks the initiating user's phone number from the destination user, ensuring that the destination user cannot see, extract, or directly contact the initiating user's actual phone number or other direct endpoint identifier. Similarly, the system masks the destination user's phone number from the initiating user, preventing the initiating user from obtaining direct contact information that the destination user has chosen not to disclose. This bidirectional masking ensures that both parties remain protected by the relay architecture. The masking is enforced at the messaging gateway level, where outbound messages are rewritten to replace actual endpoint identifiers with the assigned relay addresses before transmission, and where inbound messages are validated to ensure they arrive via the relay channel rather than through direct contact attempts.

At step 440, the system delivers the first-contact message via relay. The interaction control server sends an introduction message to the destination user from the system relay address rather than from the initiating user's actual phone number. The message includes contextual information such as where and when the activation occurred, what event or venue context applies, and any mutual affiliations or shared context. The message also includes initiating user information such as the initiating user's name or pseudonym, a self-introduction if provided, and an avatar or image if available and permitted, but explicitly does not include the initiating user's phone number or other direct contact information. The message may be formatted as a rich introduction card if the selected protocol supports enhanced features and permissions allow, or as plain text if a constrained protocol is used. The message clearly indicates that it is being delivered through a privacy-protected relay channel and may include instructions on how the destination user can respond through the relay.

At step 450, the system maintains the relay path for responses. If the destination user responds to the introduction message, the interaction control server routes the response messages through the relay channel rather than establishing direct communication. Both users communicate via system addresses, not direct numbers, with all messages passing through the messaging gateway where endpoint rewriting and relay routing are enforced. The initiating user receives messages appearing to originate from the system relay address, and the destination user receives messages appearing to originate from a different system relay address. Neither user sees the other's actual phone number or direct endpoint identifier. The relay path may be maintained across multiple message exchanges, enabling a full conversation to occur while preserving privacy. The relay session may support bidirectional messaging, media exchange if permitted by protocol and policy, and other communication features available through the selected protocol, all while maintaining endpoint masking.

At step 460, the system preserves session continuity. The interaction control server links all relayed messages to the session identifier assigned in step 420, ensuring that conversation thread identity and attribution are maintained despite the use of masked endpoints. The session record accumulates a complete history of the conversation including message content, timestamps, delivery status, read receipts if available, and any user actions such as message deletion or conversation archiving. This session continuity enables the system to present a coherent conversation view to both users, to maintain context across protocol transitions if fallback becomes necessary, and to support features such as conversation search, notification management, and relationship-state tracking. The session identifier also enables the system to correctly route future messages in the conversation even if relay addresses are rotated, reused, or reassigned over time.

At step 470, the system optionally releases direct contact information if release conditions are satisfied. The interaction control server evaluates one or more release conditions to determine whether direct contact disclosure should be permitted. Release conditions may include affirmative approval by the destination user through an explicit “share contact” action, achievement of a trust threshold based on accumulated positive interactions and absence of moderation flags, elapsed time such as a minimum interaction period or sustained communication over a defined duration, mutual verification where both users have confirmed their identities through platform verification processes, or explicit destination user override where the destination user manually authorizes direct disclosure. If release conditions are satisfied, the system may release direct contact information to one or both users, transitioning the communication from relay-mediated to direct while still preserving the relationship-state record and accumulated context. If release conditions are not satisfied, the system maintains the relay indefinitely, allowing the communication to continue through masked channels for as long as the relationship persists. In some embodiments, the relay may be maintained permanently, with direct contact information never disclosed, while the platform continues to provide the communication channel as a persistent service. The decision to release or maintain relay is logged in the relationship-state object associated with the user pair, enabling consistent handling of future interactions and providing transparency to users about their privacy status.

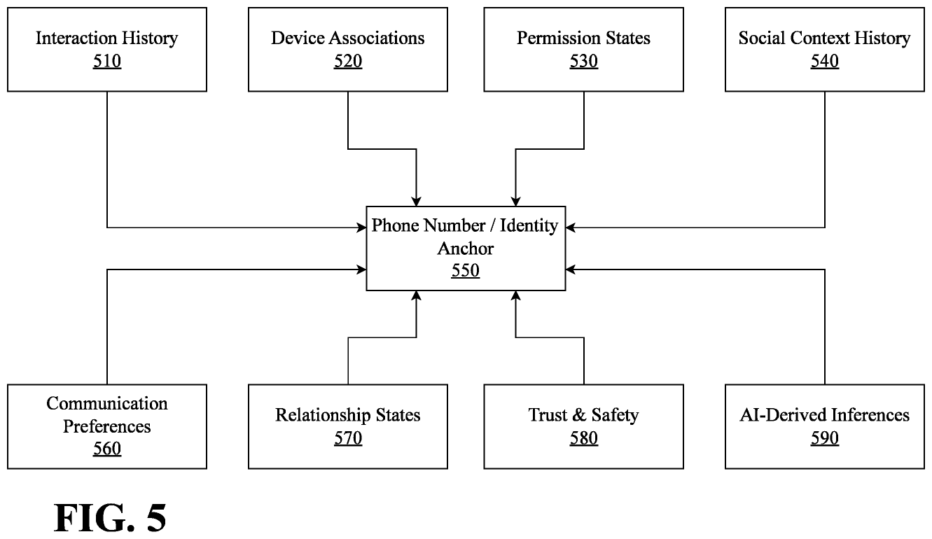

FIG. 5 is a block diagram illustrating a persistent identity profile structure for a destination user. The diagram shows the various data elements and records that comprise a destination user identity profile, demonstrating how the platform maintains a comprehensive, phone-number-anchored persistent record that accumulates contextual intelligence across multiple sessions, venues, time periods, and communication modalities.

At the center of the identity profile is a phone number or identity anchor 550, which serves as the stable identifier to which all other profile elements are linked. The phone number anchor 550 provides persistence across devices, sessions, applications, and time periods, enabling the platform to recognize the same user identity regardless of which device is currently active, which communication protocol is being used, or how much time has elapsed since the last interaction. In some embodiments, the identity anchor 550 may comprise a phone number as the primary identifier with supplemental identifiers such as email addresses, verified platform account identifiers, device identifiers, or federated identity tokens stored as associated or secondary identity elements. The use of a phone number as the primary anchor is advantageous because phone numbers are relatively stable, widely used across communication protocols, subject to carrier-level verification, and already function as de facto user identifiers in messaging ecosystems.

The identity profile includes interaction history 510, which stores a chronological record of all communication events, activation events, and platform interactions associated with the destination user. Interaction history 510 may include records of when and where the destination user's activation assets were activated by initiating users, what first-contact requests were received and whether they were accepted, declined, or deferred, what messages were exchanged in relay-mediated or direct conversations, what protocol transitions occurred during sessions, what moderation events or safety flags were raised, and what relationship-state transitions occurred as interactions matured over time. The interaction history 510 enables the platform to learn from past behavior and optimize future communications based on accumulated intelligence rather than treating each interaction as an isolated event.

The identity profile includes device associations 520, which track the devices linked to the destination user's identity. Device associations 520 may include records of device types such as smartphones, tablets, laptops, or wearables, device identifiers such as hardware identifiers or platform-specific tokens, device capabilities such as supported protocols, screen sizes, or installed applications, last-known active devices and their timestamps, and push notification tokens or other device-specific communication endpoints. Device associations 520 enable the platform to determine which communication protocols are technically feasible for a given user, to route notifications and messages to the appropriate device, to detect device changes that might affect protocol preferences, and to identify suspicious patterns such as multiple devices being used in inconsistent ways.

The identity profile includes permission states 530, which govern whether and how socially initiated communications are permitted for the destination user. Permission states 530 may include global permission settings indicating the default privacy posture for unsolicited first-contact attempts, context-specific permissions that apply different rules depending on whether the activation occurred at a conference, nightlife venue, campus, or other environment, asset-specific permissions that apply different rules to different activation assets maintained by the same user, relationship-specific permissions that apply different rules to communications from users with whom prior relationships have been established, and temporal permissions that vary based on time of day, day of week, or user-configured availability windows. Permission states 530 may specify whether communications are blocked entirely, allowed only through masked relay, allowed only after approval, allowed with basic text capabilities, allowed with enhanced protocol features, or allowed with direct contact disclosure. The permission state records also store transition history documenting when and why permission levels changed, enabling audit trails and supporting user transparency about their privacy configuration.

The identity profile includes social context history 540, which records the venues, events, campaigns, and media sources through which the destination user's activation assets have been deployed or encountered. Social context history 540 may include records of conferences or events where the user's badge-based activation assets were used, nightlife venues where table markers or wearable tokens were activated, campus environments where directory or orientation codes were deployed, residential communities or club memberships where activation assets were distributed, creator or fan engagement contexts where profile-based activation assets were shared, and digital campaigns or media placements where activation links were published. Each context record may include the context identifier, context name and type, geographic location, date range during which the context was active, and statistics such as how many activations occurred in that context and what the conversion rate to accepted communications was. Social context history 540 enables the platform to provide rich provenance in first-contact messages, to apply context-appropriate trust scoring and permission rules, and to support analytics about which social environments produce the most valuable networking opportunities for the destination user.

The identity profile includes communication preferences 560, which store learned or explicitly configured preferences about how the destination user prefers to receive and respond to communications. Communication preferences 560 may include preferred protocols such as a preference for RCS over SMS or app-based messaging over email, timing preferences such as preferred hours for receiving communications or deferment policies for late-night or early-morning messages, response patterns such as typical response latency or preferred message length, notification preferences such as whether the user prefers immediate alerts or batched summaries, and feature preferences such as whether the user engages with rich introduction cards or prefers plain text formats. Some communication preferences 560 may be explicitly configured by the user through settings interfaces, while others may be inferred by AI analysis of the user's historical behavior patterns. These preferences enable the platform to optimize message delivery timing, protocol selection, and content formatting to align with the destination user's demonstrated or stated preferences.

The identity profile includes relationship states 570, which link the destination user to initiating users with whom prior interactions have occurred. Each relationship state record may store the identity of the other user in the relationship, first-contact provenance describing when, where, and how the relationship was initiated, approval state indicating whether the initial contact was accepted, declined, or is still pending, current communication mode indicating whether the relationship is operating through masked relay or has transitioned to direct contact, protocol history showing which protocols have been used for communications within this relationship, trust indicators such as cumulative trust scores or moderation flags specific to this relationship, interaction frequency and recency metrics, mutual context such as shared affiliations or multiple venues where the pair has encountered each other, and privacy-release state indicating what level of contact information disclosure has occurred. Relationship states 570 enable the platform to recognize follow-up communications as continuations of existing relationships rather than novel first-contact attempts, to apply relationship-specific permission and routing rules, and to support features such as “show me all contacts from this event” or “how did I meet this person.”

The identity profile includes trust and safety data 580, which stores security-relevant information and risk indicators associated with the destination user. Trust and safety 580 may include trust scores calculated based on verification status, interaction history, and behavioral patterns, moderation history including any reports filed by other users about this user's behavior, policy violation records if the user has engaged in spam, abuse, or other prohibited conduct, fraud indicators such as suspicious device patterns or identity verification failures, safety settings configured by the user such as enhanced screening requirements or block lists, and verification status including whether the user has completed identity verification processes, linked verified accounts, or obtained platform badges. Trust and safety data 580 is used by the platform to protect other users from harmful interactions, to inform permission and routing decisions, to trigger enhanced AI screening when risk factors are present, and to support moderation and enforcement actions when necessary.

The identity profile includes AI-derived inferences 590, which store insights and predictions generated by artificial intelligence analysis of the destination user's behavior, preferences, and patterns. AI-derived inferences 590 may include inferred communication preferences not explicitly configured but learned from behavior, predicted response likelihood for different types of first-contact requests, inferred relationship categories such as whether the user tends to use the platform primarily for professional networking, social connections, dating, or community engagement, timing optimization recommendations such as predicted best times to deliver communications for maximum response likelihood, content preferences such as inferred preferences for brief or detailed introductions, safety and appropriateness predictions about what types of communications the user is likely to find acceptable versus objectionable, and contextual affinity scores indicating which types of venues or events produce the most successful connections for this user. AI-derived inferences 590 enable the platform to continuously improve the quality, relevance, and safety of communications delivered to the destination user without requiring constant manual configuration, while still respecting the user's ability to override AI recommendations through explicit permission settings.

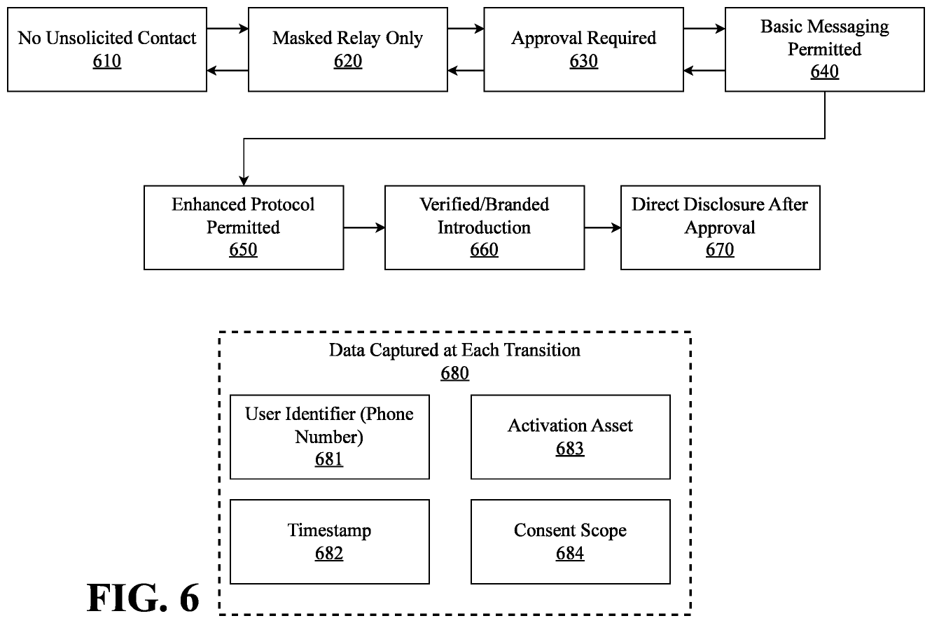

FIG. 6 is a state diagram illustrating multi-state permissions governing socially initiated communications. The diagram shows the various permission states that may be configured for a destination user, the transitions that can occur between these states, and the data captured at each transition to maintain audit trails and support user transparency about privacy configuration. This multi-state permission architecture enables nuanced, context-aware control over socially initiated interactions that conventional binary contact settings cannot achieve.

The permission state model includes a no unsolicited contact state 610, in which the destination user does not permit any first-contact attempts from unknown initiating users. In this state, activation of the destination user's activation assets may result in the interaction being blocked entirely, logged for later review but not delivered, or converted into a contact request capture that is held indefinitely without notifying the destination user. This state provides the highest level of privacy protection and may be appropriate for users who wish to maintain activation assets for specific known contexts while preventing general public access. Transitions out of the no unsolicited contact state 610 may occur when the user explicitly configures a more permissive setting, when the user manually approves a specific pending request, or when administrative or event-specific policies override the global setting for a limited scope.

The permission state model includes a masked relay only state 620, in which first-contact communications are permitted but only through privacy-preserving relay channels that mask endpoint identifiers. In this state, an initiating user can send an introduction message that will be delivered to the destination user, but neither user's direct phone number or other endpoint identifier is disclosed to the other party. All messages pass through system-controlled relay addresses, and the communication may continue indefinitely through the relay without transitioning to direct contact. This state provides a balance between accessibility and privacy, allowing meaningful conversations while preserving anonymity. Transitions into the masked relay only state 620 may occur from the no unsolicited contact state 610 when the user wishes to become more accessible, or from more permissive states when the user wishes to increase privacy protections.

The permission state model includes an approval required state 630, in which first-contact attempts are delivered to the destination user as approval requests rather than as full messages. In this state, the initiating user's introduction is held by the platform pending affirmative acceptance by the destination user. The destination user receives an approval object showing the initiating user's identity information, contextual provenance about where and when the activation occurred, any AI-generated trust or safety scores, and controls to accept, decline, defer, or request additional information. If the destination user accepts the request, a communication channel is opened and messages can be exchanged, potentially through masked relay or with direct contact disclosure depending on the destination user's subsequent permission configuration. If the destination user declines the request, the initiating user is notified that the request was not accepted, and no substantive communication occurs. The approval required state 630 provides the destination user with explicit control over which first-contact attempts proceed, making it suitable for contexts where the destination user wishes to evaluate each request individually before committing to communication.

The permission state model includes a basic messaging permitted state 640, in which first-contact communications are allowed to proceed through basic text-based protocols without requiring approval. In this state, an initiating user can send an introduction message that will be delivered to the destination user via SMS, MMS, or other plain-text protocols, and the destination user receives the message directly without needing to explicitly approve the contact attempt. The communication may be masked or direct depending on other permission settings, but the key characteristic of this state is that basic protocol messages are delivered without gating. This state provides relatively open accessibility while potentially limiting the richness of the communication format. Transitions into the basic messaging permitted state 640 may occur from more restrictive states when the user wishes to become more accessible, or from more permissive states when the user wishes to constrain the types of introductions received.

The permission state model includes an enhanced protocol permitted state 650, in which first-contact communications are allowed to proceed using rich, interactive, and branded communication features available through enhanced protocols such as RCS. In this state, an initiating user can send a rich introduction card containing structured identity information, interactive buttons, contextual provenance, images, and verified sender indicators, which will be delivered to the destination user if the technical capabilities of both devices and carriers support the enhanced protocol. The enhanced protocol permitted state 650 enables the highest-quality first-contact experience and is suitable for contexts where the destination user wishes to receive detailed, well-formatted introductions that take full advantage of modern messaging capabilities. The system may still apply safety screening, trust scoring, and other mediation even when enhanced protocols are permitted. Transitions into the enhanced protocol permitted state 650 may occur from more restrictive states when the user wishes to enable richer communications, or may be context-specific such that enhanced protocols are permitted for conference-originated contacts but not for nightlife-originated contacts.

The permission state model includes a verified or branded introduction state 660, in which first-contact communications are permitted only when the initiating context, organization, or user has been verified by the platform or by external verification services. In this state, an activation asset may be configured to require that introductions include verified sender identity, verified event or venue context, verified organizational affiliation, or other trust signals that have been cryptographically or procedurally validated. This state is particularly useful for event organizers, venue operators, or community administrators who wish to ensure that only authenticated participants can initiate communications through their activation assets. The verification requirements may vary by context, with some contexts requiring lightweight verification such as event registration confirmation, while others require stronger verification such as government-issued identity document validation or institutional email confirmation. Transitions into the verified or branded introduction state 660 may occur when a user enrolls in a verified event or community, when a venue operator configures verification requirements, or when the user explicitly enables verification requirements as a trust filter.

The permission state model includes a direct disclosure after approval state 670, in which the destination user's direct contact information may be released to an initiating user after one or more approval or trust conditions are satisfied. In this state, initial first-contact attempts may still proceed through masked relay or approval workflows, but once the destination user accepts a request, once a trust threshold is reached through accumulated positive interactions, once a minimum interaction period has elapsed, or once other release conditions are met, the platform may disclose the destination user's actual phone number or other direct endpoint identifier to the initiating user, enabling the pair to communicate directly without continued platform mediation. The direct disclosure after approval state 670 provides a pathway for relationships to mature from privacy-protected introduction to direct contact, recognizing that many users ultimately wish to exchange direct contact information with connections they trust, while still maintaining privacy controls for the initial interaction phase.

At each transition between permission states, the system captures data to maintain audit trails and support transparency. Data captured at each transition 680 includes a user identifier such as the phone number 681 of the destination user whose permission state is changing, a timestamp 682 indicating when the transition occurred, an activation asset identifier 683 if the transition is scoped to a specific activation asset rather than being a global permission change, and a consent scope 684 indicating the breadth of the permission change such as whether it applies globally to all contexts, only to a specific event or venue, only to a specific activation asset, or only to a specific relationship with another user.

The user identifier phone number 681 ensures that permission state transitions are correctly attributed to the appropriate user identity, enabling the platform to maintain separate permission histories for different users and to correctly apply permission rules when processing subsequent interaction events. The timestamp 682 provides temporal context for the permission change, enabling the platform to understand how a user's privacy preferences have evolved over time, to support queries such as “what was this user's permission state on a specific date,” and to detect suspicious patterns such as rapid permission state changes that might indicate account compromise. The activation asset identifier 683 enables asset-specific permission configuration, allowing a destination user to maintain multiple activation assets with different permission levels suited to different social contexts, such as a permissive asset for professional networking events and a restrictive asset for general public use. The consent scope 684 defines the extent to which the permission change applies, enabling fine-grained control where a user might approve contact from a specific person without changing the global permission state, or might enable enhanced protocols for conference contexts while maintaining basic protocols for other contexts.

This multi-state permission architecture enables destination users to configure privacy and communication preferences that align with their individual needs, social contexts, and risk tolerance, while providing the platform with the information necessary to enforce those preferences consistently across all interaction events. The ability to transition between states based on user actions, system-detected conditions, or contextual factors enables progressive relationship maturation and adaptive privacy control that static binary settings cannot support.

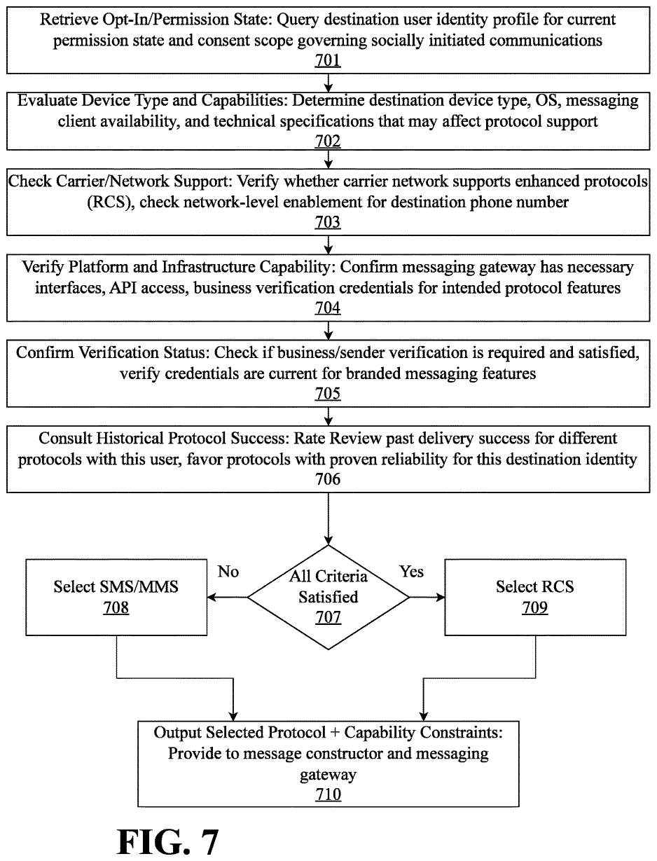

FIG. 7 is a method diagram illustrating channel-eligibility determination for social-contact initiation across multiple protocols. The diagram shows the sequence of evaluation steps through which the interaction control server determines whether a socially initiated communication should be delivered via SMS, MMS, RCS, app-based messaging, web chat, email, or another available communication mode, based on permission state, device capability, carrier support, historical protocol success, destination-user preference, and present reachability conditions.

The process begins at step 701, where the system retrieves the opt-in or permission state. The interaction control server queries the destination user identity profile for the current permission state and consent scope governing socially initiated communications. This retrieval determines what types of communications are permitted, whether enhanced protocol features are allowed, whether approval is required, whether only masked relay is permitted, and what contextual constraints apply to the current interaction. The permission state may be global to the destination user, specific to the activation asset being used, specific to the event or venue context from which the activation occurred, or specific to the relationship between the initiating user and destination user if a prior relationship exists. The consent scope defines the breadth of the permission, indicating whether it applies to all communications, only to certain contexts, or only to certain communication modes.

At step 702, the system evaluates device type and capabilities. The interaction control server determines the destination device type such as smartphone, tablet, feature phone, or other device category, the operating system such as iOS, Android, or other mobile platforms, the messaging client availability including whether native messaging apps, third-party messaging apps, or web-based messaging interfaces are installed and active, and the technical specifications that may affect protocol support such as screen size, network connectivity, installed app versions, and platform API levels. This device evaluation may be performed by querying device associations stored in the destination user identity profile, by performing real-time device capability probing through the messaging gateway, by consulting external device capability databases maintained by carriers or messaging platforms, or by inferring device characteristics from historical interaction patterns. The device evaluation determines which protocols are technically feasible given the destination user's current device configuration.

At step 703, the system checks carrier and network support. The interaction control server verifies whether the carrier network serving the destination user's phone number supports enhanced protocols such as RCS, checks network-level enablement for the destination phone number to determine whether advanced messaging features have been provisioned by the carrier, queries carrier capability APIs or databases to determine what specific RCS features are available such as rich cards, verified sender displays, or file transfer capabilities, and evaluates current network conditions that might affect protocol selection such as whether the device is currently on a data network versus a voice-only network. Carrier support varies significantly across networks, regions, and phone number types, with some carriers fully supporting RCS with all features, some supporting RCS with limited features, and others not supporting RCS at all. The carrier check ensures that the selected protocol will actually be deliverable given the destination user's carrier infrastructure.

At step 704, the system verifies platform and infrastructure capability. The interaction control server confirms that the messaging gateway has the necessary interfaces, API access, authentication credentials, and technical integrations required to deliver messages through the intended protocol. This verification includes checking whether the messaging gateway has established connections with the appropriate carrier messaging hubs for SMS and MMS delivery, whether the gateway has access to RCS Business Messaging platforms or carrier RCS APIs for enhanced protocol delivery, whether the gateway has business verification credentials required for branded messaging features, whether rate limits or sending quotas are available for the intended volume of messages, and whether any regulatory or compliance requirements such as A2P registration or short code provisioning have been satisfied. Platform and infrastructure capability may vary by geographic region, carrier, or message type, and the verification step ensures that the gateway is actually capable of delivering the selected protocol rather than selecting a protocol that will fail at the delivery stage.

At step 705, the system confirms verification status. The interaction control server checks whether business or sender verification is required for the intended communication and whether such verification is satisfied. Certain enhanced protocol features such as RCS verified sender badges, branded message headers, or rich media cards may require that the sender has been verified by the messaging platform, carrier, or a third-party verification service. The verification check determines whether the current interaction qualifies for verified sender treatment, whether verification credentials are current and have not expired, whether the verification scope covers the intended use case such as event-based networking versus commercial messaging, and whether any additional verification steps need to be completed before delivery. If verification is required but not satisfied, the system may select a protocol that does not require verification, may defer the message pending verification completion, or may deliver a simplified version of the message without verified sender features.

At step 706, the system consults historical protocol success rates. The interaction control server reviews past delivery success for different protocols with this user, favoring protocols with proven reliability for this destination identity. The historical analysis examines what protocols have been used in prior communications with this destination user, what the delivery success rates were for each protocol such as whether messages were successfully delivered, whether they were read, and whether they generated responses, what protocol failures have occurred such as RCS fallback to SMS or undeliverable messages, what the destination user's response patterns are for different protocols such as whether the user engages more actively with rich cards versus plain text, and what timing and contextual factors correlate with successful delivery and engagement. By consulting historical protocol success, the system can learn over time which protocols work best for each individual user rather than applying a one-size-fits-all protocol selection strategy. For users with no prior history, the system may rely on global statistics, cohort-based predictions, or default protocol hierarchies.

At step 707, the system determines whether all criteria are satisfied. Based on the evaluations performed in steps 701 through 706, the interaction control server assesses whether an enhanced protocol such as RCS can be used or whether a fallback protocol such as SMS or MMS must be selected. The criteria satisfaction check evaluates whether permission state allows enhanced protocol features, whether the destination device is capable of receiving and rendering enhanced protocol messages, whether the carrier network supports the enhanced protocol for this destination phone number, whether the platform infrastructure can deliver through the enhanced protocol, whether verification requirements are met if applicable, and whether historical success rates suggest that the enhanced protocol is likely to result in successful delivery and engagement. If all criteria are satisfied, the system proceeds to select RCS or another enhanced protocol. If any criterion is not satisfied, the system selects a fallback protocol such as SMS or MMS that is more universally supported.

If the criteria check at step 707 determines that all criteria are satisfied, the system proceeds to step 709 and selects RCS or another enhanced protocol. The selection of RCS enables the delivery of rich introduction cards with structured identity information, interactive buttons, contextual provenance, images, and verified sender indicators, providing the highest-quality first-contact experience. The RCS selection may also include selection of specific RCS features to use such as suggested replies, carousels, or rich cards, depending on what features are supported by the destination device and carrier. In some embodiments, the system may select alternative enhanced protocols such as app-based messaging through platform-native applications, web-based messaging through browser interfaces, or email with rich HTML formatting, depending on what enhanced capabilities are available and appropriate for the context.

If the criteria check at step 707 determines that one or more criteria are not satisfied, the system proceeds to step 708 and selects SMS or MMS as a fallback protocol. The selection of SMS or MMS ensures that the message can be delivered even when enhanced protocol capabilities are unavailable, unsupported by the destination device or carrier, disallowed by permission state, or unlikely to succeed based on historical patterns. SMS and MMS provide universal compatibility across virtually all mobile devices and carriers, ensuring that first-contact communications can reach destination users regardless of their device or network configuration. The fallback to SMS or MMS may involve simplified message formatting, removal of rich media elements, conversion of interactive buttons to numbered text options, and other adaptations to fit within the constraints of basic text messaging protocols.

At step 710, the system outputs the selected protocol plus capability constraints. The interaction control server provides the selected protocol and associated capability constraint information to the capability-aware message constructor and the messaging gateway. The output includes the protocol identifier such as RCS, SMS, or MMS, the specific feature set available within that protocol such as character limits, media support, button support, or verified sender features, any formatting constraints such as maximum message length, image dimensions, or button counts, any delivery constraints such as rate limits or time-of-day restrictions, and any session continuity information such as the session identifier that should be maintained if protocol fallback occurs later. The capability-aware message constructor uses this information to generate a message artifact adapted to the selected protocol and constraints, while the messaging gateway uses this information to route the message through the appropriate delivery infrastructure and to apply any protocol-specific transformations required for successful transmission. This output ensures that the message construction and delivery stages operate with complete information about what capabilities are available and what constraints apply, enabling the system to preserve interaction intent while adapting presentation to protocol realities.

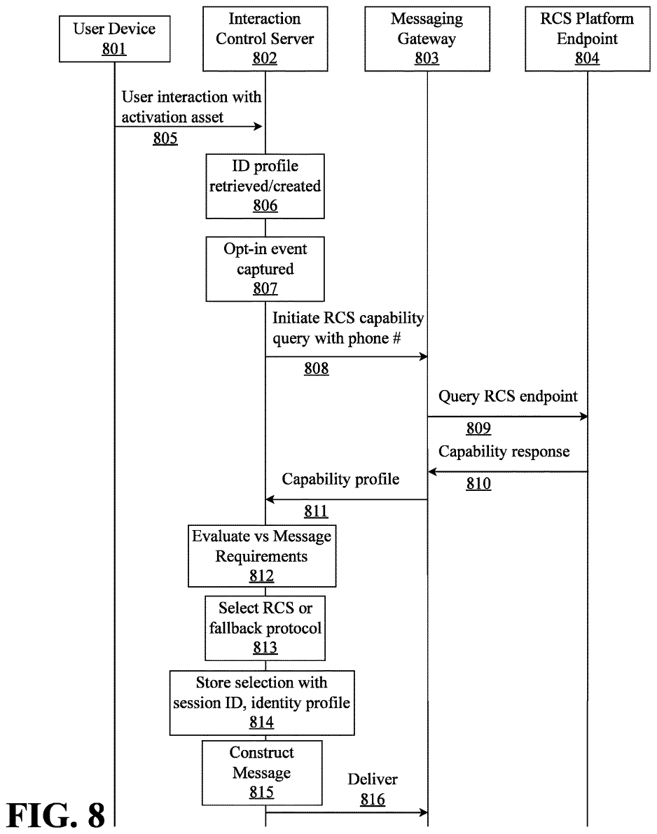

FIG. 8 is a sequence diagram illustrating capability negotiation and protocol selection for a first-contact message. The diagram shows the temporal interaction sequence among a user device, an interaction control server, a messaging gateway, and an RCS platform endpoint, demonstrating how the system queries external messaging infrastructure to determine protocol availability and capabilities before constructing and delivering a first-contact communication.

The sequence begins with a user device 801 initiating user interaction with an activation asset at step 805. The user device 801 may comprise a smartphone, tablet, or other computing device through which an initiating user scans a QR code, taps an NFC token, clicks a redirect link, or otherwise activates a digital activation asset associated with a destination user. The activation generates an interaction event that is transmitted from the user device 801 to the interaction control server 802. The interaction event contains information such as the activation asset identifier, contextual metadata about where and when the activation occurred, device information describing the user device 801, timestamp data, and potentially initiating-user-provided introduction content.

Upon receiving the interaction event, the interaction control server 802 performs identity profile retrieval or creation at step 806. The interaction control server 802 resolves the activation asset identifier to a destination user identity profile, which is a persistent phone-number-anchored record maintained by the platform. If the destination user identity profile already exists, the server retrieves it from a datastore. If this is a new destination user or a new activation asset, the server may create a new identity profile or link the asset to an existing profile. The retrieved or created identity profile contains accumulated interaction history, device associations, protocol usage patterns, permission states, social context history, communication preferences, relationship states, trust and safety data, and AI-derived inferences that inform subsequent processing steps.

At step 807, the interaction control server 802 captures an opt-in event associated with the interaction. The opt-in event records that a destination user has exposed an activation asset for social communication initiation, that an initiating user has activated that asset, and that the resulting communication is governed by the permission states and consent scope associated with the destination user identity profile. The opt-in event may include the user identifiers for both the initiating user and destination user, the activation asset identifier, the timestamp of the activation, contextual metadata such as event or venue identifiers, the applicable permission state at the time of activation, and the consent scope indicating what types of communications are permitted. This opt-in capture supports regulatory compliance requirements, enables audit trails for privacy and consent management, and provides the foundation for relationship-state tracking if the interaction progresses.

The interaction control server 802 then initiates an RCS capability query with the destination user's phone number at step 808. The server sends a capability query request to the messaging gateway 803, providing the destination user's phone number and requesting information about whether the destination user's device and carrier support RCS messaging and what specific RCS features are available. The capability query may also include information about the intended message type, such as whether a rich introduction card, verified sender badge, or interactive buttons are planned, enabling the messaging gateway to assess whether the destination infrastructure can support the specific features the interaction control server intends to use.

At step 809, the messaging gateway 803 queries the RCS platform endpoint 804. The messaging gateway 803 forwards the capability query to an external RCS platform endpoint 804, which may comprise a carrier-operated RCS messaging hub, an RCS Business Messaging platform operated by Google or another messaging provider, an intercarrier RCS interconnect service, or another authoritative source of RCS capability information. The query provides the destination phone number and requests a capability response indicating whether RCS is available for that number, what version of the RCS specification is supported, what specific features are enabled such as rich cards, suggested replies, file transfer, location sharing, or read receipts, whether verified sender features are available, and what message size limits or other constraints apply.

The RCS platform endpoint 804 responds with a capability response at step 810. The capability response indicates whether the destination phone number is RCS-enabled, meaning that the associated device and carrier support RCS messaging, what the feature support level is such as whether basic RCS text messaging, rich RCS cards, or advanced RCS features like chatbots are supported, whether the destination is currently reachable via RCS or whether the device is offline or in a network state that prevents RCS delivery, what the maximum message size and media size limits are, whether verified sender badges and branded message headers are supported, and any other technical constraints or capabilities relevant to message construction and delivery. If RCS is not available, the response may indicate this explicitly or may time out, signaling that fallback to a universal protocol like SMS is necessary.

The messaging gateway 803 returns the capability profile to the interaction control server 802 at step 811. The capability profile is a structured data object containing the RCS availability status, the supported feature set, the technical constraints, and any additional information needed by the interaction control server to make an informed protocol selection decision. The capability profile may also include information about alternative protocols such as whether app-based messaging through a platform-native application is available, whether web-based messaging is feasible, or whether SMS and MMS are the only universally available options.

At step 812, the interaction control server 802 evaluates the capability profile against message requirements. The server compares what the destination user's infrastructure can support, as indicated by the capability profile, against what the intended first-contact message requires based on permission state, contextual richness, trust indicators, and interaction goals. The evaluation determines whether the destination can receive a rich introduction card with interactive buttons, contextual provenance, images, and verified sender indicators, or whether the message must be simplified to plain text with numbered options and text-based context descriptions. The evaluation may also consider historical protocol success rates for this destination user, current message queue priorities, and any time-sensitive constraints affecting the communication.

At step 813, the interaction control server 802 selects RCS or a fallback protocol. If the capability profile indicates that RCS is available, that the destination infrastructure supports the required features, and that permission state allows enhanced protocol messaging, the server selects RCS as the delivery protocol. If RCS is unavailable, if required features are not supported, if permission state restricts enhanced messaging, or if historical data suggests that RCS delivery is unreliable for this destination user, the server selects a fallback protocol such as SMS or MMS. The protocol selection decision is determinative for the message construction phase and affects how the introduction will be formatted and delivered.

At step 814, the interaction control server 802 stores the protocol selection with the session identifier and identity profile. The server records which protocol was selected, why it was selected based on the evaluation performed in step 812, what the capability constraints are for the selected protocol, and what the session identifier is that links all events associated with this communication thread. This stored information enables session continuity if protocol fallback becomes necessary later, supports analytics about protocol selection patterns, provides audit trails for debugging delivery issues, and enriches the destination user identity profile with additional protocol usage history that informs future protocol selection decisions. The session identifier is critical for maintaining thread identity if the communication progresses through multiple message exchanges or if protocol transitions occur during the conversation.

At step 815, the interaction control server 802 constructs the message. Using a capability-aware message constructor, the server generates a first-contact communication artifact adapted to the selected protocol and the capability constraints identified in the protocol selection process. If RCS was selected, the constructor creates a rich introduction card with structured identity information, the initiating user's name or pseudonym and avatar, contextual provenance describing where and when the activation occurred, interactive buttons such as accept, decline, defer, or reply controls, branded or verified sender indicators if verification is satisfied, images or media content if appropriate and permitted, and trust or safety indicators generated by AI analysis. If SMS or MMS was selected as a fallback, the constructor creates a plain text message with substantially the same interaction intent rendered in simplified form, including numbered reply options, text-based contextual descriptions, and concise introductions adapted to character limits. The constructed message preserves the session identifier and other metadata necessary for delivery and subsequent processing.

At step 816, the messaging gateway 803 delivers the constructed message to the destination user. The messaging gateway 803 receives the message artifact from the interaction control server 802, routes it through the appropriate protocol-specific delivery infrastructure such as carrier SMS centers, RCS Business Messaging platforms, or app-based messaging services, applies any protocol-specific formatting or encoding transformations required for transmission, tracks delivery status including sent, delivered, read, and failed states, and returns delivery confirmation or failure notifications to the interaction control server 802. If delivery through the selected protocol fails, the messaging gateway 803 may signal the interaction control server 802 to initiate a fallback sequence, triggering the session continuity manager to retrieve the session state, regenerate the message for an alternative protocol, and reattempt delivery while preserving thread identity and context. This delivery step completes the first-contact initiation sequence, with the message now in the hands of the destination user who can review the introduction and decide whether to accept, decline, defer, or respond to the communication request.

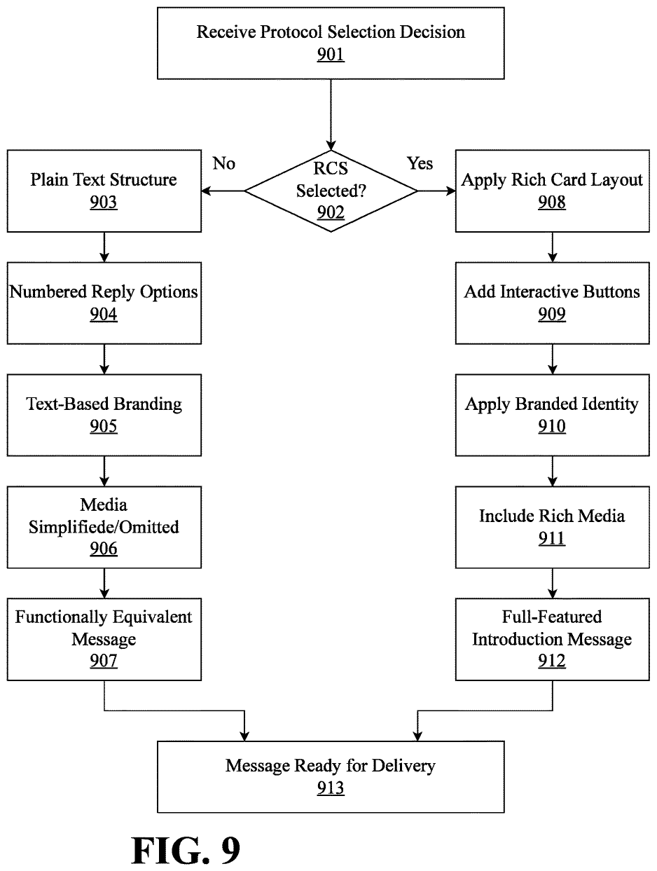

FIG. 9 is a flowchart illustrating capability-aware message construction for enhanced and fallback protocols. The diagram shows how the interaction control server constructs a first-contact communication artifact adapted to the selected protocol and associated capability profile, demonstrating the divergent construction paths for rich introduction cards delivered via enhanced protocols such as RCS versus plain text messages delivered via fallback protocols such as SMS or MMS, while preserving functional equivalence and interaction intent across both construction paths.

The process begins at step 901, where the system receives the protocol selection decision from the channel eligibility service. This decision indicates which communication protocol has been selected for delivering the first-contact message, such as RCS for enhanced messaging or SMS/MMS for fallback messaging, along with associated capability constraints such as character limits, media support, button support, or verified sender features. The protocol selection decision is based on evaluations of permission state, device capability, carrier support, platform infrastructure capability, verification status, and historical protocol success rates as performed in the channel eligibility determination process illustrated in FIG. 7 and the capability negotiation sequence illustrated in FIG. 8.

At step 902, the system determines whether RCS is selected. This decision point branches the message construction process into two distinct paths: a fallback protocol path for constructing plain text messages when RCS is not selected, and an enhanced protocol path for constructing rich introduction cards when RCS is selected. The branching reflects the fundamental difference in capabilities between constrained protocols that support only plain text and limited formatting versus enhanced protocols that support structured data, interactive controls, rich media, and branded sender features.

If RCS is not selected at step 902, indicating that a fallback protocol such as SMS or MMS must be used, the system proceeds to the plain text construction path beginning at step 903. At step 903, the system applies a plain text structure to the message. The capability-aware message constructor formats the introduction as a linear text message using simple formatting, paragraph breaks, and plain-language descriptions. The plain text structure presents the initiating user's identity information, contextual provenance about where and when the activation occurred, and the purpose of the communication in a readable narrative form that does not rely on visual layout, structured data fields, or interactive controls. The text is composed to fit within the character limits of SMS, typically 160 characters per segment with concatenation for longer messages, or MMS, which supports longer text and media attachments within size constraints.

At step 904, the system adds numbered reply options. Since the fallback protocol does not support interactive buttons or structured reply controls, the constructor provides numbered text options that the destination user can reference in their reply. For example, the message might include “Reply 1 to Accept, 2 to Decline, 3 to Ask How We Met, 4 to Defer” at the end of the introduction text. These numbered options provide functional equivalence to the interactive buttons available in rich introduction cards, enabling the destination user to respond with structured input by simply sending a reply containing the appropriate number. The system can then parse the destination user's reply to determine which action was selected and process it accordingly, maintaining the same interaction logic as the enhanced protocol path while using a text-based interface.

At step 905, the system applies text-based branding. Since the fallback protocol does not support visual branding elements such as logos, color schemes, or verified sender badges, the constructor includes branding information as text within the message body. For example, the message might begin with “From: Tech Summit 2024 Networking” or “Verified Contact via Club Nexus” to convey sender identity and context in textual form. The text-based branding provides transparency about the source of the communication and establishes context, serving a similar function to the visual branding elements available in enhanced protocols, but rendered as plain language rather than as structured visual markers.

At step 906, the system simplifies or omits media. Since SMS does not support media and MMS supports only limited media types with size constraints, the constructor either omits media elements such as images or avatars entirely, provides text descriptions of visual content such as “Photo: Conference badge with blue lanyard,” or includes shortened URLs linking to web-hosted versions of media content if appropriate and permitted by policy. The media simplification ensures that the message can be delivered through the fallback protocol while preserving as much of the original intent as possible within the technical constraints.

At step 907, the system produces a functionally equivalent message ready for delivery. The plain text message contains substantially the same information and interaction intent as would be present in a rich introduction card: the initiating user's identity, contextual provenance, trust or safety indicators if relevant, and response options. Although the presentation is simplified and constrained by the limitations of plain text messaging, the semantic content and functional capabilities are preserved, enabling the destination user to understand who is contacting them, why, and how to respond. The functionally equivalent message ensures that users on devices or networks that do not support enhanced protocols still receive meaningful, actionable first-contact communications rather than degraded or broken experiences.

If RCS is selected at step 902, indicating that an enhanced protocol with rich messaging capabilities can be used, the system proceeds to the enhanced protocol construction path beginning at step 908. At step 908, the system applies a rich card layout to the message. The capability-aware message constructor formats the introduction as a structured RCS rich card using visual layout regions, data fields, and design elements. The rich card layout organizes content into clearly defined sections such as a header with sender identity, a body with contextual information and introduction text, a media region for images or avatars, and a footer with interactive controls. The layout uses visual hierarchy, spacing, and styling to present information in a polished, professional, and easily scannable format that takes full advantage of the enhanced protocol's rendering capabilities.

At step 909, the system adds interactive buttons to the rich card. The constructor includes structured button controls such as “Accept,” “Decline,” “Defer,” “Ask How We Met,” or “Reply” that the destination user can tap to provide structured input. These buttons are rendered as tappable UI elements within the messaging client, providing a native app-like interaction experience. When the destination user taps a button, the messaging client sends a structured response back to the platform indicating which action was selected, enabling the interaction control server to process the response programmatically without requiring natural language parsing. The interactive buttons provide superior usability compared to numbered text options, reducing friction and cognitive load for the destination user.

At step 910, the system applies branded identity to the rich card. The constructor includes visual branding elements such as a verified sender badge displaying the event, venue, or organization name with a verification checkmark, a logo or icon representing the sender context, color schemes or visual styling consistent with the event or venue brand, and sender identification text formatted with enhanced typography. The branded identity establishes trust and provides immediate visual context about the source and nature of the communication, enabling the destination user to quickly assess the legitimacy and relevance of the first-contact attempt. If business verification credentials are available and the verification status was confirmed during protocol selection, the branding may include platform-native verified sender indicators that appear at the operating system or messaging client level.

At step 911, the system includes rich media in the message. The constructor adds media elements such as the initiating user's avatar or profile image if provided and permitted, contextual images such as event logos, venue photos, or badge graphics that reinforce the provenance of the communication, background images or visual styling that create an immersive card experience, and potentially video or audio content if supported by the protocol and appropriate for the context. The rich media enhances the visual appeal and informativeness of the introduction, enabling the destination user to process context and identity information more quickly and intuitively than would be possible with text alone.

At step 912, the system produces a full-featured introduction message ready for delivery. The rich RCS card contains comprehensive identity information, contextual provenance, interactive controls, visual branding, and media content, providing the highest-quality first-contact experience available within the technical and policy constraints of the system. The full-featured message leverages all available capabilities of the enhanced protocol to create a polished, professional, and user-friendly introduction that maximizes the likelihood of successful communication establishment while preserving privacy, consent, and contextual transparency.

At step 913, the message is ready for delivery. Regardless of whether the construction path followed the plain text fallback flow through steps 903 through 907 or the rich enhanced flow through steps 908 through 912, the capability-aware message constructor has produced a protocol-appropriate message artifact that preserves the interaction intent, maintains functional equivalence across construction paths, and is formatted for successful transmission through the selected protocol. The message artifact is delivered to the messaging gateway along with session metadata including the session identifier, protocol selection information, capability constraints, delivery preferences, and fallback instructions. The messaging gateway then handles the actual transmission of the message to the destination user device, completing the first-contact communication initiation sequence. The capability-aware construction approach ensures that all destination users, regardless of their device or network configuration, receive meaningful and actionable first-contact communications adapted to their technical capabilities while maintaining a consistent underlying interaction model across protocols.

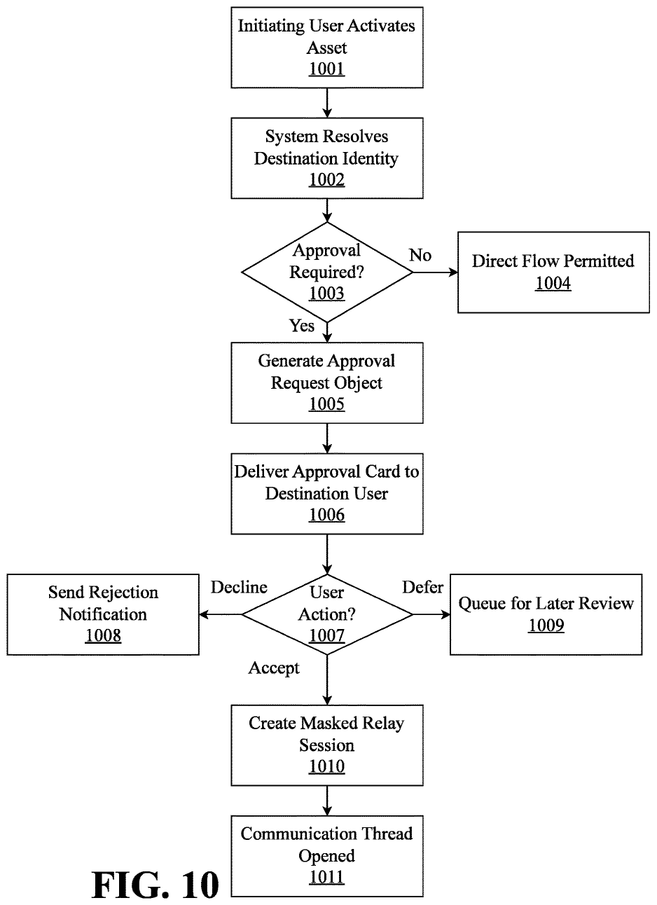

FIG. 10 is a method diagram illustrating an approval-required or mutual-consent communication initiation flow. The diagram shows the sequence of steps through which the system processes a first-contact attempt when the destination user's permission state requires explicit approval before substantive communication can occur, demonstrating how the platform mediates consent-gated interactions while preserving contextual provenance and enabling multiple response pathways for the destination user.

The process begins at step 1001, where the initiating user activates an asset. The initiating user scans a QR code, taps an NFC token, clicks a redirect link, or otherwise activates a digital activation asset associated with a destination user. The activation generates an interaction event that is transmitted from the initiating user's device to the interaction control server. The interaction event contains information such as the activation asset identifier, contextual metadata describing where and when the activation occurred, device information about the initiating user's device, a timestamp, and potentially initiating-user-provided introduction content such as a self-written message or self-identification information.

At step 1002, the system resolves the destination identity. The interaction control server receives the interaction event and resolves the activation asset identifier to a destination user identity profile, which is a persistent phone-number-anchored record maintained by the platform. The resolution process involves querying a persistent identity management service to retrieve the destination user identity profile based on the asset identifier. The retrieved profile contains accumulated interaction history, device associations, protocol usage patterns, permission states, social context history, communication preferences, relationship states, trust and safety data, and AI-derived inferences. The system also retrieves contextual information associated with the activation event, such as the event or venue identifier, geographic location, and any mutual affiliations or shared context between the initiating user and destination user.

At step 1003, the system determines whether approval is required. The interaction control server evaluates the permission state retrieved from the destination user identity profile to determine whether first-contact communications must be approval-gated or whether they may proceed directly. The approval requirement may be a global setting indicating that the destination user requires explicit consent for all unsolicited communications, a context-specific setting indicating that approval is required for contacts originating from certain venues or events such as nightlife contexts but not for others such as professional conferences, an asset-specific setting indicating that approval is required for certain activation assets but not others, or a relationship-specific setting indicating that approval is required for unknown initiating users but not for users with whom prior relationships have been established. The system may also consider trust scores, AI-derived safety indicators, and contextual factors in determining whether approval should be required even if the permission state would otherwise allow direct communication.

If the determination at step 1003 indicates that approval is not required, the system proceeds to step 1004 and allows direct flow. In the direct flow path, the first-contact message is delivered to the destination user without requiring explicit approval, and the communication may proceed through masked relay, direct messaging, or other pathways as determined by the applicable permission state and protocol selection logic. The direct flow path is described in greater detail in other figures such as FIG. 3, FIG. 7, and FIG. 9, which illustrate activation, channel selection, and message construction for non-approval-gated communications.

If the determination at step 1003 indicates that approval is required, the system proceeds to step 1005 and generates an approval request object. The interaction control server constructs an approval request object rather than delivering the initiating user's full message content immediately. The approval request object contains information necessary for the destination user to make an informed consent decision, including the initiating user's identity information such as name or pseudonym, avatar or profile image if provided, and any verified credentials or affiliation markers, contextual provenance describing where and when the activation occurred such as the event name, venue name, timestamp, and activation method, an introduction preview showing a portion or summary of the initiating user's message if one was provided, AI-generated trust or safety scores indicating the assessed risk level of the communication, and interactive controls enabling the destination user to accept the request, decline the request, defer the request for later review, request additional information such as clarification about how the users met, or report the request as spam or abuse.

At step 1006, the system delivers the approval card to the destination user. The interaction control server sends the approval request object to the destination user device through the messaging gateway using the selected communication protocol. The approval card may be delivered as an RCS rich card with interactive buttons and structured layout if enhanced protocols are available, as a plain text message with numbered response options if fallback protocols must be used, as an app-based notification if the destination user has the platform application installed, as a web-based approval interface accessible through a link, or through other delivery modalities depending on device capability and protocol availability. The approval card clearly indicates that this is a first-contact request requiring approval and that the substantive message content will only be delivered or the communication channel will only be opened if the destination user affirmatively accepts the request.

At step 1007, the system awaits user action. The destination user reviews the approval card and selects one of the available response options. The user action decision point branches into three primary pathways: decline, defer, or accept. Each pathway represents a different destination user intent regarding whether and how the communication should proceed. The user action is captured by the messaging client on the destination user device and transmitted back to the interaction control server as a structured response indicating which action was selected, potentially along with additional input such as a reason for declining or a message to the initiating user.

If the destination user selects decline at step 1007, the system proceeds to step 1008 and sends a rejection notification to the initiating user. The interaction control server generates and delivers a rejection notification informing the initiating user that the destination user has declined the first-contact request. The rejection notification may be brief and generic, such as “Your contact request was not accepted,” without providing detailed reasons in order to respect the destination user's privacy and avoid creating pressure for the destination user to justify the decision. The rejection notification may optionally include high-level feedback if the destination user chose to provide it, such as “User indicated they do not recall meeting you” or “User is not interested in networking at this time.” The rejection is logged in the interaction history for both users, and no further communication channel is opened between the pair. The initiating user may be prevented from making repeated contact attempts to the same destination user for a cooling-off period to prevent harassment or spam.

If the destination user selects defer at step 1007, the system proceeds to step 1009 and queues the request for later review. The interaction control server holds the approval request in a pending state without delivering the full message content or opening a communication channel. The queued request is stored in the destination user's pending contacts list or approval queue, where it can be reviewed at a later time when the destination user has more context, more time to evaluate requests, or greater willingness to engage with new contacts. The defer action enables the destination user to avoid making an immediate decision while preserving the option to accept or decline at a future time. The initiating user may receive a notification indicating that their request is pending, or may receive no immediate feedback if the destination user prefers to defer without notification. The queued request may expire after a defined period such as 30 days, 60 days, or 90 days if no action is taken, at which point it is automatically declined or archived.

If the destination user selects accept at step 1007, the system proceeds to step 1010 and creates a masked relay session. The interaction control server establishes a relay-mediated communication channel through which the initiating user and destination user can exchange messages while maintaining endpoint privacy. The relay session creation involves assigning a unique session identifier that links all messages and events associated with this communication thread, allocating system-controlled relay addresses such as temporary relay phone numbers or app-based relay endpoints through which messages will pass, masking the initiating user's phone number from the destination user and masking the destination user's phone number from the initiating user, and recording the session metadata including the identities of both users, the approval timestamp, the contextual provenance of the original activation, and the applicable permission states and communication preferences. The masked relay session enables substantive conversation while preserving privacy and maintaining platform mediation of the communication.

At step 1011, a communication thread is opened. With the masked relay session established, the interaction control server delivers the initiating user's full message content to the destination user if a message was held pending approval, or enables the initiating user and destination user to begin exchanging messages if no initial message content was provided. The communication thread operates through the relay channel, with all messages passing through the platform's messaging gateway where endpoint rewriting and relay routing are enforced. The destination user can respond to the initiating user's messages, and the conversation can continue across multiple message exchanges while maintaining session continuity and privacy protection. The system also creates or updates a relationship-state object linking the initiating user and destination user, storing first-contact provenance, approval state, communication preferences specific to the pair, protocol history, trust indicators, and privacy-release state. This relationship-state object enables future interactions between the same pair to be recognized as continuations of an established relationship rather than novel first-contact attempts, allowing the system to apply relationship-specific permissions and avoid requiring repeated approval for follow-up communications. The opened communication thread represents a successful transition from a consent-gated first-contact request to an active, ongoing conversation mediated by the platform's privacy-preserving relay infrastructure.

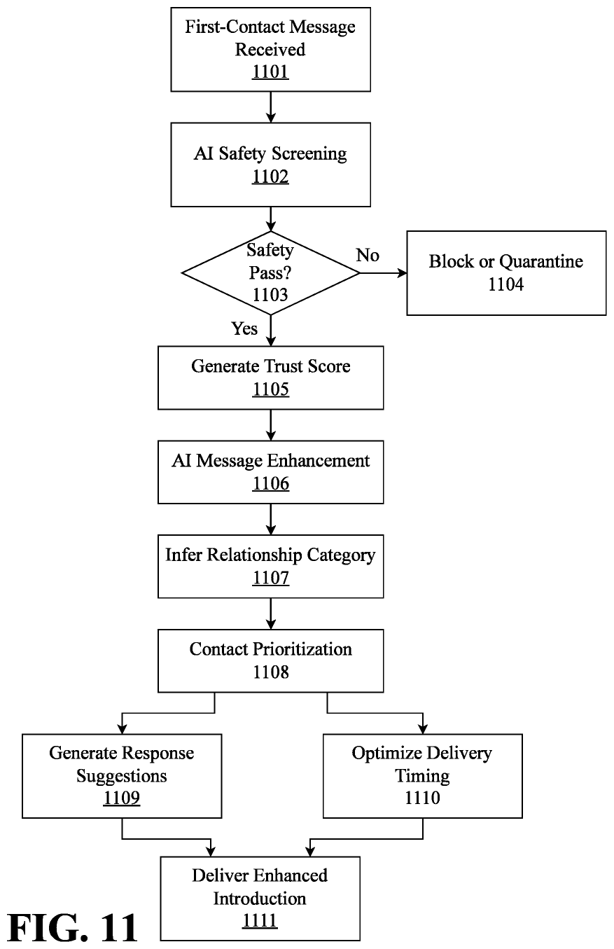

FIG. 11 is a method diagram illustrating artificial-intelligence-assisted safety screening, message enhancement, response suggestion, and contact prioritization. The diagram shows the sequence of AI-mediated processing steps through which the system analyzes, improves, and optimizes socially initiated communications to enhance safety, quality, relevance, and user experience before delivering first-contact introductions to destination users.

The process begins at step 1101, where a first-contact message is received. The interaction control server receives a first-contact communication event resulting from an initiating user's activation of a destination-user-associated activation asset. The received message may include the initiating user's self-provided introduction text, identity information such as name or pseudonym, contextual metadata about where and when the activation occurred, device information, and any other content provided during the activation process. This raw first-contact message serves as the input to a series of AI-assisted mediation steps designed to improve the quality, safety, and relevance of the communication before it reaches the destination user.

At step 1102, the system performs AI safety screening. An artificial-intelligence mediation engine analyzes the first-contact message for safety and policy concerns using machine learning models, natural language processing, pattern recognition, and heuristic rules. The AI safety screening examines the message content for spam indicators such as repetitive text, commercial solicitations, unsolicited promotions, or bulk messaging patterns, abuse or harassment including threatening language, explicit content, hate speech, or targeted harassment, fraud signals such as phishing attempts, impersonation, financial scams, or social engineering tactics, policy violations including prohibited content types, terms of service violations, or regulatory non-compliance, and quality indicators such as message coherence, grammatical correctness, and apparent effort level. The screening process generates a safety assessment that may include a binary pass/fail determination, a graduated risk score on a numerical scale, specific flags for detected issues, and confidence levels for each assessment.

At step 1103, the system determines whether the safety check passes. Based on the AI safety screening results from step 1102, the interaction control server evaluates whether the first-contact message meets minimum safety and quality thresholds required for delivery to the destination user. The safety pass determination may consider the overall risk score, the presence or absence of high-severity flags, the destination user's configured safety threshold settings, the trust level of the initiating user if available from prior interaction history, and contextual factors such as whether the activation occurred in a moderated event environment or an unmoderated public context. If the message contains clear violations such as explicit spam, severe abuse, or obvious fraud, the safety check fails. If the message appears legitimate but contains minor quality issues or ambiguous signals, the safety check may pass with caveats that inform subsequent processing steps.

If the safety check fails at step 1103, the system proceeds to step 1104 and blocks or quarantines the message. The interaction control server prevents the message from being delivered to the destination user, protecting the destination user from unwanted, harmful, or policy-violating communications. The blocking action may be immediate and permanent, removing the message entirely and preventing the initiating user from making further contact attempts to the same destination user, or may involve quarantining the message for human moderator review, allowing a human safety specialist to assess whether the AI screening produced a false positive and whether the message should be released or permanently blocked. The initiating user may receive a notification that their message was rejected due to policy violations, or may receive no notification if the system determines that providing feedback would enable the initiating user to refine spam or abuse tactics. The blocked or quarantined event is logged in the interaction history for both users and may contribute to trust scores, moderation histories, and platform-wide safety analytics.

If the safety check passes at step 1103, the system proceeds to step 1105 and generates a trust score for the interaction. The AI mediation engine calculates a trust score representing the assessed legitimacy, quality, and appropriateness of the first-contact attempt. The trust score is based on multiple factors including the results of the safety screening from step 1102, the quality and coherence of the message content, the contextual provenance of the activation such as whether it occurred at a verified event or an unverified public location, the initiating user's history if available including prior approval rates, response rates, and moderation flags, the destination user's preferences and historical acceptance patterns, mutual context such as shared affiliations or connections, device and network signals that may indicate suspicious patterns, and timing factors such as whether the contact attempt occurs at an unusual hour or with suspicious frequency. The generated trust score may be represented as a numerical value on a scale such as 0 to 100, a categorical rating such as low, medium, or high trust, or a multidimensional vector capturing different aspects of trustworthiness. The trust score is used in subsequent processing steps to inform prioritization, delivery timing, and presentation to the destination user.

At step 1106, the system performs AI message enhancement. The AI mediation engine analyzes the first-contact message and applies improvements to enhance clarity, professionalism, social appropriateness, and effectiveness. Message enhancement may include grammar and spelling correction to fix typographical errors, punctuation mistakes, or grammatical issues without changing the semantic meaning, style normalization to adjust tone, formality, or verbosity to align with social norms appropriate for the activation context, ambiguity reduction to clarify unclear references, provide additional context, or restructure confusing sentences, language translation if the initiating user and destination user use different primary languages and translation is permitted by policy, content summarization if the original message is excessively long and a more concise version would improve readability, and inappropriate content filtering to remove or soften language that is overly casual, potentially offensive, or socially inappropriate for a first-contact situation. The enhanced message preserves the initiating user's intent and core content while improving the presentation to increase the likelihood of a positive reception by the destination user. In some embodiments, the initiating user may be shown the enhanced version and given the option to approve or modify it before it is delivered, while in other embodiments the enhancement occurs transparently without initiating user involvement.

At step 1107, the system infers the relationship category. The AI mediation engine analyzes the first-contact message, the activation context, and available user information to infer what type of relationship the initiating user is attempting to establish. Relationship categories may include professional networking where the contact is career-oriented, skill-sharing, or business development focused, social friendship where the contact is casual, personal, or activity-based, romantic or dating where the contact expresses romantic interest or dating intent, community or residential where the contact relates to shared living spaces, neighborhoods, or local organizations, academic or educational where the contact relates to coursework, study groups, or educational institutions, fan or creator engagement where one user is following, supporting, or engaging with the other user's creative work, or transactional or service-oriented where the contact relates to a specific transaction, service request, or practical need. The inferred relationship category influences how the introduction is framed, what response options are suggested, what privacy defaults apply, and how the relationship-state object is structured if the interaction progresses. The category inference is probabilistic and may assign multiple categories with confidence scores rather than a single deterministic classification.

At step 1108, the system performs contact prioritization. The interaction control server determines the priority level or queue position for the first-contact request based on the trust score from step 1105, the inferred relationship category from step 1107, the destination user's historical preferences and response patterns, the contextual relevance of the activation such as whether it aligns with the destination user's current activities or interests, time-sensitivity indicators such as whether the activation occurred at an ongoing event versus a past event, and platform-level factors such as overall message volume and queue management. High-trust, contextually relevant contacts from verified events may be prioritized for immediate delivery, while lower-trust or less contextually aligned contacts may be placed in lower-priority queues, batched for periodic delivery, or held for review during the destination user's next active session. Contact prioritization enables the destination user to see the most relevant and valuable first-contact requests first, reducing cognitive load and improving the overall quality of the networking experience.

At step 1109, the system generates response suggestions for the destination user. The AI mediation engine creates suggested responses that the destination user can use to reply to the first-contact request with minimal effort. Response suggestions may include acceptance responses such as “Great to meet you!” or “Looking forward to connecting,” decline responses such as “Thank you, but I'm not interested in connecting at this time” or “I don't recall meeting you,” clarification requests such as “Can you remind me where we met?” or “Can you tell me more about what you'd like to discuss?” deferral responses such as “I'll review this later” or “Let me get back to you,” and contextually specific responses tailored to the inferred relationship category such as “I'd be interested in learning more about your work” for professional contexts or “That event was great! Happy to stay in touch” for social contexts. The suggested responses reduce friction for the destination user by eliminating the need to compose original reply text, while still allowing the destination user to customize or ignore the suggestions if they prefer to write their own response. The suggestions are generated based on the content of the first-contact message, the contextual provenance, the destination user's historical response patterns, and natural language generation models trained on successful communication outcomes.

At step 1110, the system optimizes delivery timing. The interaction control server determines the optimal time to deliver the first-contact introduction to the destination user based on the destination user's historical activity patterns, preferred notification times, or explicitly configured availability windows, the time-sensitivity of the contact such as whether it relates to an ongoing event or can be delivered asynchronously, the destination user's current context such as whether they are likely to be working, sleeping, or available based on time zone and typical schedules, platform usage patterns indicating when the destination user typically checks messages and is most likely to respond, and message queue dynamics such as whether immediate delivery would result in the message being buried by other notifications or whether scheduled delivery would improve visibility. The optimized timing may result in immediate delivery if conditions are favorable, scheduled delivery at a future time when the destination user is more likely to be receptive, batched delivery where multiple first-contact requests are grouped together for periodic review, or event-triggered delivery where the message is held until a specific condition is met such as the destination user opening the application or completing a current activity. Delivery timing optimization improves response rates and user satisfaction by respecting the destination user's time and attention constraints.

At step 1111, the system delivers the enhanced introduction to the destination user. The interaction control server constructs the final first-contact communication artifact incorporating all improvements and optimizations from the preceding AI-mediation steps. The delivered introduction includes the enhanced message content from step 1106, trust or safety indicators derived from the trust score in step 1105, contextual framing based on the inferred relationship category from step 1107, the suggested responses generated in step 1109, and any additional metadata or controls appropriate for the selected communication protocol and the destination user's permission state. The introduction is delivered through the messaging gateway at the optimized time determined in step 1110 and at the priority level determined in step 1108. The delivered introduction represents a significantly improved version of the original first-contact message, benefiting from AI-assisted screening, enhancement, categorization, prioritization, and optimization to maximize safety, quality, relevance, and the likelihood of a successful connection between the initiating user and destination user.

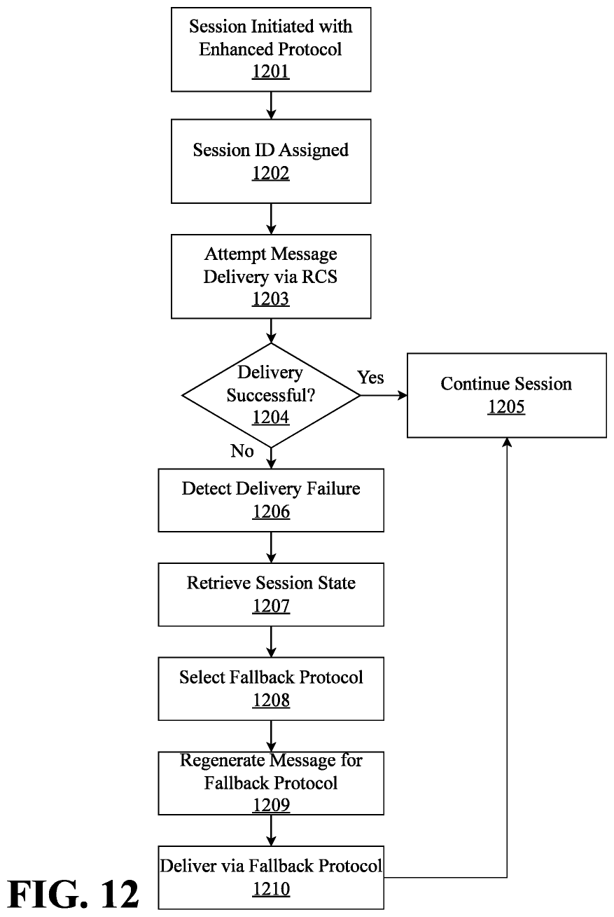

FIG. 12 is a method diagram illustrating session continuity and protocol fallback during an ongoing socially initiated communication. The diagram shows the sequence of steps through which the system preserves thread identity, context, and interaction intent when delivery through an initially selected enhanced protocol fails and the message must be regenerated and retransmitted through a fallback protocol, demonstrating how session continuity mechanisms ensure that communication can proceed without loss of attribution, relationship-state continuity, or conversation history.

The process begins at step 1201, where a session is initiated with an enhanced protocol. The interaction control server has completed the channel eligibility determination process illustrated in FIG. 7 and the capability negotiation sequence illustrated in FIG. 8, resulting in the selection of an enhanced protocol such as RCS for delivering the first-contact message. The enhanced protocol selection indicates that the destination user's device and carrier support rich messaging capabilities, that permission state allows enhanced features, that the messaging gateway has the necessary infrastructure to deliver through the enhanced protocol, and that verification status and other requirements are satisfied. The system constructs a rich introduction card using the capability-aware message construction process illustrated in FIG. 9, creating a full-featured message with structured layout, interactive buttons, branded identity, and rich media content.

At step 1202, a session identifier is assigned. The session continuity manager within the interaction control server assigns a unique session identifier to this socially initiated interaction. The session identifier is a persistent token that links together all messages, events, state changes, and metadata associated with this communication thread. The session record stores the initiating user identifier and destination user identifier, the activation asset identifier and contextual provenance describing where and when the activation occurred, the selected protocol and capability constraints, the permission state and consent scope applicable to the interaction, the constructed message content and any attachments or media, timing information including session creation timestamp and any scheduled delivery times, and relationship-state linkages if a prior relationship exists between the initiating user and destination user. The session identifier enables the system to maintain thread identity and context continuity across multiple message exchanges, protocol transitions, device changes, and time periods, ensuring that all events associated with this interaction remain connected in a coherent conversation history.

At step 1203, the system attempts message delivery via RCS. The messaging gateway receives the constructed rich introduction card and the session metadata from the interaction control server and attempts to transmit the message to the destination user device using the RCS protocol. The delivery attempt involves routing the message through RCS Business Messaging platforms, carrier RCS hubs, or other RCS infrastructure, encoding the message according to RCS specifications including rich card format, media encoding, and interactive control definitions, including verification credentials and branded sender information if applicable, transmitting the message over data networks to the destination device, and monitoring for delivery confirmation signals such as sent status, delivered status, read receipts, or failure notifications. The RCS delivery attempt may succeed immediately if all systems are functioning correctly and the destination device is reachable, or may fail for various technical reasons.

At step 1204, the system determines whether delivery is successful. The messaging gateway evaluates the delivery attempt outcome based on responses from RCS infrastructure, carrier networks, and the destination device. Delivery success indicators include confirmation that the message was successfully transmitted to the RCS platform, confirmation that the message was delivered to the destination device, delivery receipts indicating that the message was received by the messaging client on the destination device, and optionally read receipts indicating that the destination user has opened and viewed the message. Delivery failure indicators include timeout errors where the destination device does not acknowledge receipt within a defined time window, network errors where RCS infrastructure or carrier systems return error codes indicating that delivery cannot be completed, device capability errors where the destination device unexpectedly lacks RCS support despite earlier capability checks indicating availability, protocol version mismatches where the destination device supports RCS but not the specific features used in the message, and reachability errors where the destination device is offline, in airplane mode, or otherwise unreachable via data networks.

If delivery is successful at step 1204, the system proceeds to step 1205 and continues the session. The session remains active with the enhanced protocol, and the communication thread proceeds normally. The destination user receives the rich introduction card as intended and can interact with the interactive buttons, view the rich media, and respond to the initiating user. All subsequent messages in the conversation continue to be linked to the session identifier assigned in step 1202, enabling coherent conversation threading, context preservation, and relationship-state tracking. The session continuity manager monitors the ongoing conversation for any future protocol transitions or delivery issues, but in the success case, no immediate intervention is required.

If delivery is not successful at step 1204, indicating that the RCS delivery attempt has failed, the system proceeds to step 1206 and detects the delivery failure. The messaging gateway captures detailed failure information including the specific error code or failure reason returned by RCS infrastructure, the timestamp when the failure occurred, the stage of delivery at which the failure occurred such as during transmission, during carrier routing, or during final device delivery, and any diagnostic information provided by the messaging platforms or carrier systems. This failure information is reported to the interaction control server, triggering the protocol fallback sequence designed to recover from the delivery failure without losing the communication thread or requiring the initiating user to manually retry the contact attempt.

At step 1207, the system retrieves the session state. The session continuity manager queries the session record using the session identifier assigned in step 1202 to retrieve all information associated with this communication thread. The retrieved session state includes the original message content including the initiating user's introduction text, identity information, and any media or attachments, the contextual provenance describing where and when the activation occurred, the initiating user identifier and destination user identifier, the permission state and consent scope governing the interaction, the relationship-state linkage if applicable, the original protocol selection decision and the reasons for that selection, and any prior delivery attempts or protocol transitions that have already occurred. By retrieving the complete session state, the system ensures that the fallback delivery attempt will preserve all relevant context and will present the destination user with the same semantic content and interaction intent as the failed enhanced protocol delivery would have provided.

At step 1208, the system selects a fallback protocol. The channel eligibility service within the interaction control server determines which alternative protocol should be used for the retry attempt. The fallback protocol selection process considers which protocols are universally available such as SMS or MMS, which protocols have been proven to work for this destination user based on historical delivery success rates stored in the destination user identity profile, which protocols are permitted by the current permission state and consent scope, which protocols can convey the essential interaction intent even if they lack the rich features of the original enhanced protocol, and which protocols have adequate capacity and are not subject to rate limits or sending restrictions. In most cases, the fallback protocol is SMS or MMS, which provide near-universal compatibility across devices and carriers, though in some embodiments the fallback might be to app-based messaging, web-based messaging, or email if those channels are available and appropriate for the context.

At step 1209, the system regenerates the message for the fallback protocol. The capability-aware message constructor, following the process illustrated in FIG. 9, reconstructs the first-contact introduction adapted to the capability constraints of the selected fallback protocol. The regeneration process converts the rich introduction card that was intended for RCS delivery into a plain text message suitable for SMS or MMS delivery, transforming structured layout regions into linear text paragraphs, converting interactive buttons into numbered text options such as “Reply 1 to Accept, 2 to Decline, 3 to Ask How We Met,” replacing visual branding elements with text-based sender identification, omitting or simplifying media content that cannot be transmitted via the fallback protocol or providing text descriptions or shortened URLs in place of inline media, and condensing verbose content to fit within character limits while preserving the core message meaning. Critically, the regenerated message maintains the same session identifier assigned in step 1202, ensuring that the destination user's response will be correctly associated with the original session and that conversation continuity is preserved despite the protocol change.

At step 1210, the system delivers the message via the fallback protocol. The messaging gateway transmits the regenerated message through the fallback protocol infrastructure, such as carrier SMS centers for SMS delivery or MMS servers for MMS delivery. The fallback delivery uses the same session identifier and session metadata as the original enhanced protocol attempt, ensuring that from the perspective of the interaction control server and the session continuity manager, this is a continuation of the same communication thread rather than a new, disconnected message. The delivery via fallback protocol has a much higher probability of success than the failed enhanced protocol attempt because SMS and MMS are supported by virtually all mobile devices and carrier networks, do not require data connectivity or advanced messaging client features, and have mature, reliable infrastructure with extensive fallback and retry mechanisms at the carrier level. Upon successful delivery via the fallback protocol, the communication thread proceeds as intended, with the destination user receiving a functionally equivalent introduction that preserves the interaction intent, contextual provenance, and response options, albeit in a simplified presentation format. The session continuity mechanisms ensure that subsequent messages in the conversation remain linked to the session identifier, that the relationship-state object correctly reflects that communication was established despite the protocol transition, and that future interactions between the same pair of users can reference the complete interaction history including the protocol fallback event. This fallback and continuity architecture enables the disclosed system to provide reliable communication initiation across heterogeneous device and network environments while maintaining the persistence, context, and attribution that distinguish identity-linked social communication from conventional contact-exchange mechanisms.

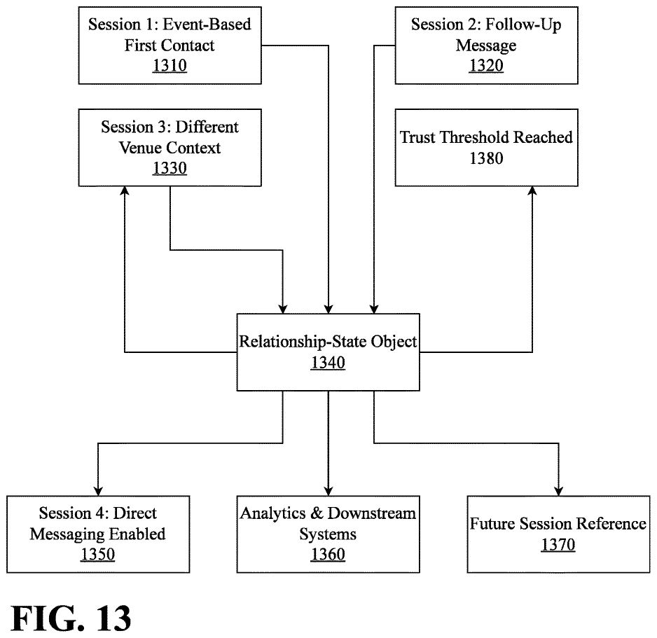

FIG. 13 is a data-flow diagram illustrating relationship-state persistence across multiple sessions, contexts, and communication channels. The diagram shows how a single persistent relationship-state object accumulates data from diverse interaction events over time, enabling progressive relationship maturation from initial masked introduction through optional direct contact disclosure, and supporting downstream analytics and system integrations with comprehensive relationship intelligence.

At the center of the diagram is the relationship-state object 1340, which is a persistent data structure maintained by the platform that links an initiating user and a destination user across all interactions between them. The relationship-state object 1340 serves as the authoritative record of the relationship between the user pair, storing first-contact provenance that documents when, where, and how the relationship was initiated including the event or venue identifier, activation timestamp, activation asset used, and initial contextual metadata, approval state indicating whether the initial contact was accepted, declined, or deferred by the destination user, current communication mode indicating whether the relationship operates through masked relay, approval-required flows, or direct contact, protocol transition history documenting all protocol changes that have occurred during the relationship lifecycle such as RCS to SMS fallback or relay to direct transition, trust indicators including cumulative trust scores, moderation flags, safety assessments, and verification status specific to this relationship, interaction frequency and recency metrics tracking how often the users communicate and when the last interaction occurred, mutual context such as shared affiliations, multiple venues where the pair has encountered each other, or common connections, and privacy-release state indicating what level of contact information disclosure has occurred such as whether direct phone numbers have been exchanged or whether communication remains mediated through platform relay. The relationship-state object 1340 is anchored to the phone-number-based persistent identity profiles of both users, enabling the platform to recognize that interactions occurring across different sessions, devices, protocols, or time periods all belong to the same ongoing relationship.

Session 1: Event-based first contact 1310 represents the initial interaction that creates the relationship-state object 1340. In this session, an initiating user activates a destination user's activation asset at a conference, networking event, or other organized gathering. The activation occurs within a specific event context, such as a technology conference session titled “AI Ethics Panel” occurring on Mar. 15, 2024. The interaction control server resolves the destination user identity, evaluates permission state which may require approval for first-time contacts, determines channel eligibility which may result in RCS being selected for rich introduction cards, constructs and delivers a first-contact communication that includes contextual provenance about the conference event, and awaits the destination user's response. The destination user reviews the approval card showing that the initiating user met them at the specific conference session, decides to accept the contact request, and the system establishes a masked relay session through which messages can be exchanged without disclosing direct phone numbers. This initial session creates the relationship-state object 1340, populating it with the conference provenance, the accepted approval state, the masked relay communication mode, the initial protocol used, and baseline trust indicators. The arrow from session 1 1310 to the relationship-state object 1340 indicates that this session creates and initializes the persistent relationship record.

Session 2: Follow-up message 1320 represents a subsequent interaction between the same user pair occurring days after the initial contact. In this session, the initiating user sends a follow-up message to continue the conversation started at the conference. The interaction control server recognizes that this is not a new first-contact attempt but rather a continuation of an existing relationship by querying the relationship-state object 1340 and finding that the user pair already has an established communication thread. Because the relationship is recognized, the system does not require the destination user to approve the contact again, instead delivering the follow-up message directly through the existing masked relay session. The protocol selection for this session may differ from session 1, with the system selecting SMS as a fallback protocol when RCS is unavailable, demonstrating the protocol transition capability. The session continuity manager ensures that the follow-up message is correctly threaded with the initial conversation despite the protocol change. Session 2 1320 updates the relationship-state object 1340, adding the new interaction to the history, recording the protocol transition from RCS to SMS, updating interaction frequency and recency metrics, and potentially increasing trust scores based on the continued positive engagement. The arrow from session 2 1320 to the relationship-state object 1340 indicates that this session enriches and updates the persistent relationship record with new interaction data.

Session 3: Different venue context 1330 represents another interaction between the same user pair occurring at a different venue or event context from the original first contact. In this session, the initiating user and destination user encounter each other at an alumni gathering on Apr. 2, 2024, which is a different social context from the conference where they originally met. One user may activate the other's activation asset again in this new context, or they may simply continue their existing conversation through the platform. The interaction control server recognizes the existing relationship through the relationship-state object 1340 and notes that the same pair now has mutual context from multiple venues, which strengthens the relationship's legitimacy and trust indicators. The protocol selected for this session may be app-based relay chat if both users have installed the platform application, representing yet another protocol transition within the same persistent relationship. Session 3 1330 further enriches the relationship-state object 1340 by adding the alumni gathering as a second context where the users have connected, recording the app-based protocol usage in the protocol history, updating trust scores based on the multi-context validation, and documenting that the relationship has progressed beyond a single-event connection to a more sustained multi-context relationship. The arrow from session 3 1330 to the relationship-state object 1340 indicates that this session adds valuable contextual richness and validation to the persistent relationship record.

Trust threshold reached 1380 represents a state transition that occurs when the relationship-state object 1340 accumulates sufficient positive signals to warrant releasing privacy protections and enabling more direct communication. The trust threshold is determined by evaluating multiple factors stored in the relationship-state object 1340, including the number of successful interactions such as three accepted sessions with consistent positive engagement, the absence of moderation flags or safety concerns such as no spam reports, abuse reports, or policy violations, the multi-context validation such as connections occurring at both a conference and an alumni gathering, the interaction frequency and recency indicating sustained rather than one-time engagement, the trust scores accumulated across sessions showing progressive relationship development, and the elapsed time since first contact such as a minimum relationship duration of several weeks. When these factors collectively indicate that the relationship has matured beyond initial acquaintance to a trusted connection, the system determines that the trust threshold is reached. The arrow from the relationship-state object 1340 to trust threshold reached 1380 indicates that the persistent relationship record contains the accumulated intelligence that triggers this state transition, enabling the platform to automatically recognize when privacy-release conditions are satisfied without requiring manual user configuration.

Session 4: Direct messaging enabled 1350 represents the communication mode transition that occurs after the trust threshold is reached at 1380. In this session, the system releases the destination user's direct phone number to the initiating user and vice versa, transitioning from platform-mediated masked relay to direct native messaging where the users can communicate through their standard messaging applications without platform intermediation. The direct contact disclosure may be automatic upon reaching the trust threshold, or may require explicit destination user authorization even after the threshold is satisfied, depending on the destination user's configured preferences. Once direct messaging is enabled, the users exchange messages through their native SMS, RCS, or messaging apps using their actual phone numbers rather than system-controlled relay addresses. However, even after direct disclosure, the platform continues to maintain the relationship-state object 1340, tracking that the privacy-release transition occurred, recording the direct messaging phase in the protocol history, and preserving the complete provenance and interaction history from masked introduction through direct connection. The platform may continue to track high-level interaction metadata such as that the users remain in contact, without intermediating every message. The arrow from the relationship-state object 1340 to session 4 1350 indicates that the persistent relationship record enables and authorizes this transition to direct communication based on accumulated trust and relationship maturity.

Analytics and downstream systems 1360 represent the various external platforms and services that consume relationship data from the relationship-state object 1340 for analysis, reporting, and integration purposes. Downstream systems may include customer relationship management platforms that track networking connections and relationship development, moderation services that monitor for safety issues and enforce community standards, social graph services that map connection networks and identify mutual contacts, loyalty and rewards systems that credit users for successful networking outcomes, community management systems that provide venue operators and event organizers with engagement metrics, and analytics engines that generate insights about networking patterns, venue effectiveness, protocol performance, and user behavior. The relationship-state object 1340 serves as a rich, structured data source for these downstream systems, providing comprehensive information about how relationships form, develop, and mature in various social contexts. The arrow from the relationship-state object 1340 to analytics and downstream systems 1360 indicates that the persistent relationship record feeds data to external systems while the platform retains its role as the authoritative source and control plane for the communication relationship.

Future session reference 1370 represents interactions that may occur months or years after the initial relationship formation, demonstrating the long-term persistence and utility of the relationship-state object 1340. In a future session, the same user pair may reconnect after an extended period of inactivity, or one user may encounter the other's activation asset again in a new context and wonder whether they have met before. The interaction control server queries the relationship-state object 1340 and discovers the complete relationship history dating back to the original conference encounter in March 2024, enabling the system to present contextually rich information such as “You previously connected with this person at Tech Summit 2024, AI Ethics Panel, on March 15” even if the interaction is occurring years later. This historical context helps users recall past connections, provides transparency about relationship provenance, reduces duplicate contact attempts, and enables informed decisions about whether to reestablish communication. The ability to reference years-old relationship history demonstrates the value of persistent identity anchoring and long-term relationship-state maintenance, distinguishing the disclosed system from ephemeral contact-exchange mechanisms that lose context over time. The arrow from the relationship-state object 1340 to future session reference 1370 indicates that the persistent relationship record remains available indefinitely to inform future interactions and provide continuity across arbitrary time spans.

The overall data-flow pattern illustrated in FIG. 13 demonstrates how the relationship-state object 1340 serves as a hub that accumulates data from multiple sessions over time, triggers state transitions when thresholds are reached, enables downstream analytics and integrations, and supports future interactions with preserved historical context. This persistent, identity-linked relationship architecture enables progressive relationship maturation, adaptive privacy control, cross-session continuity, and long-term optimization that conventional isolated-event communication systems cannot support.

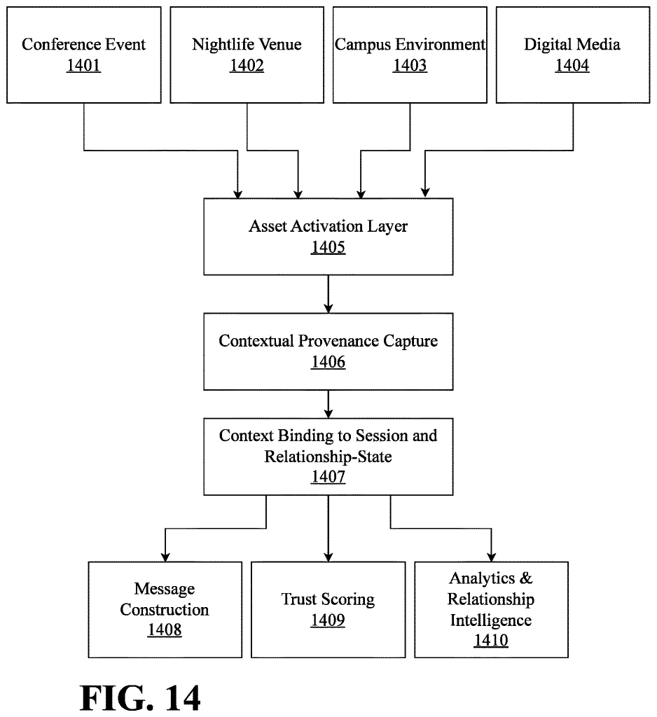

FIG. 14 is a system diagram illustrating venue-bound, event-bound, or media-bound activation assets and contextual provenance capture. The diagram shows how activation assets deployed in diverse social contexts capture and preserve machine-readable provenance describing where, when, and how users met, and how this contextual information flows through the system to inform message construction, trust scoring, analytics, and relationship intelligence, enabling richer introductions and better trust decisions than context-free contact-exchange mechanisms can provide.

The top of the diagram shows four exemplary context sources representing different social environments where activation assets may be deployed and activated. Conference event 1401 represents organized professional or educational gatherings such as technology summits, trade shows, academic conferences, industry conventions, networking events, or specialized workshops. An activation asset deployed in a conference event context may be associated with metadata including the event name such as “Tech Summit 2024,” the event date range such as Mar. 15-17, 2024, the geographic location such as San Francisco, California, the specific session or activity such as “AI Ethics Panel,” the event organizer and verification status indicating whether the event is officially registered with the platform, the venue or facility where the event occurs, the participant role such as attendee, speaker, exhibitor, or organizer, and the activation medium such as printed badge QR codes, digital event app integrations, or registration confirmation links. Conference event contexts typically have high trust levels and may enable enhanced protocol features and more permissive communication policies due to the professional nature and moderated environment.

Nightlife venue 1402 represents social entertainment establishments such as nightclubs, bars, lounges, music venues, restaurants with bar scenes, or other establishments where social interaction occurs in evening or late-night contexts. An activation asset deployed in a nightlife venue context may be associated with metadata including the venue name such as “Club Nexus,” the venue identifier such as VEN_89234, the venue type and category, the geographic location and specific sub-areas such as VIP section, main floor, or table number, the date and time of activation which may be particularly relevant in nightlife contexts where the atmosphere varies by time and day, the venue operator and verification status, any special event or theme night associated with the activation, and the activation medium such as NFC-enabled table markers, wristbands, or mobile app integrations. Nightlife venue contexts may have more restrictive privacy defaults such as requiring approval or masked relay only, and may trigger enhanced safety screening due to the less moderated environment and increased potential for inappropriate contact attempts.

Campus environment 1403 represents educational institutions and student communities such as universities, colleges, residential campuses, student housing, orientation programs, or campus organizations. An activation asset deployed in a campus environment context may be associated with metadata including the institution name and identifier, the specific campus location such as “West Hall, Floor 3,” the academic affiliation such as “Engineering Department” or “Class of 2027,” the program or activity context such as “Orientation Week” or “Student Directory,” the role such as student, faculty, staff, or visitor, verification through institutional credentials such as .edu email confirmation, and the activation medium such as student directory integrations, printed orientation materials, or campus event apps. Campus environment contexts balance accessibility for community building with safety considerations appropriate for educational settings, and may enable shared affiliation recognition where the system notes that both users are members of the same institution or program.

Digital media 1404 represents online and virtual contexts where activation assets are distributed through digital channels such as social media profiles, creator pages, online communities, promotional campaigns, streaming content overlays, email signatures, or web-based directories. An activation asset deployed in a digital media context may be associated with metadata including the media source such as “Instagram profile” or “YouTube creator page,” the campaign identifier if the asset is part of an organized outreach effort such as “Spring Tour 2024,” the media type such as “Profile Card,” “Bio Link,” or “Campaign Landing Page,” the audience scope such as public, followers-only, or community members, verification status indicating whether the creator or organization has been verified by the platform or by third-party services, and the distribution medium such as embedded links, redirect URLs, or app integrations. Digital media contexts enable broad reach and scalability but may require enhanced trust scoring and safety measures due to the lack of physical co-presence and the potential for mass distribution to unknown audiences.

All context sources feed into the asset activation layer 1405, which provides the technical infrastructure through which users interact with activation assets. The asset activation layer 1405 encompasses the digital activation assets themselves such as QR codes, NFC tokens, redirect links, visual markers, or machine-readable graphics, the activation mechanisms through which users trigger interactions such as scanning, tapping, clicking, or invoking, the asset-encoding schemes that embed destination user identifiers, context identifiers, and metadata within the assets, the asset resolution services that map activated assets to destination user identity profiles and contextual records, and the interaction event capture systems that record activation events with full temporal and contextual metadata. When a user activates an asset through the asset activation layer 1405, the system captures not only the destination user identifier and activation timestamp, but also the complete context identifier that links the activation to one of the context sources at the top of the diagram, enabling rich provenance to be preserved and propagated through subsequent processing steps.

The contextual provenance capture 1406 represents the systematic extraction and structuring of context metadata from activation events. When an activation occurs through the asset activation layer 1405, the contextual provenance capture process retrieves and stores machine-readable context including event or venue identifier and name such as the specific conference session or nightclub name, geographic location and sub-area such as city, building, floor, or table number, date, time, and session or activity context such as the specific time of activation and any associated scheduled activities, media source or campaign identifier if the activation occurred through digital channels, mutual affiliations or shared context such as both users being registered attendees of the same event or members of the same campus community, device type and activation method such as whether the user scanned a QR code with a smartphone camera or tapped an NFC token with a wearable device, and any additional contextual signals available from the activation environment such as check-in data, registration data, or user-provided context notes. The contextual provenance capture 1406 transforms raw activation events into structured, searchable, and analytically useful context records that enhance every downstream process. The arrows from the asset activation layer 1405 to contextual provenance capture 1406 indicate that activation events trigger systematic context extraction, and the arrows from contextual provenance capture 1406 to the three downstream boxes indicate that captured provenance flows to multiple consuming systems.

Context binding to session and relationship-state 1407 represents the attachment of contextual provenance metadata to session records and relationship-state objects, ensuring that context is durably preserved throughout the communication lifecycle. When a session is created following asset activation, the contextual provenance captured in step 1406 is bound to the session record, populating fields such as activation context identifier, event or venue name, activation timestamp, activation location, and context type. This binding enables the session continuity manager to maintain context across protocol transitions and message exchanges, ensuring that if the communication evolves from a first-contact approval request to an ongoing relay-mediated conversation to eventual direct messaging, the original provenance remains accessible. Similarly, when a relationship-state object is created or updated following successful communication establishment, the contextual provenance is stored as part of the relationship record, documenting where and when the relationship originated. If the same user pair later encounters each other in a different context, the new context is added to the relationship-state object as additional provenance, creating a multi-context relationship history. The context binding process ensures that provenance is not merely logged for analytics but becomes an integral, queryable, and actionable part of the persistent identity and relationship data maintained by the platform.

Message construction 1408 represents the use of contextual provenance in building first-contact communication artifacts. When the capability-aware message constructor generates an introduction card or plain text message, it incorporates contextual provenance to provide rich, informative, and trust-building context for the destination user. For an RCS-based rich introduction card, the message constructor may include a structured provenance section displaying the event or venue name with an associated icon or image, a timestamp formatted as a human-readable date and time, a location description such as “San Francisco, Tech Summit 2024, AI Ethics Panel,” and contextual labels such as “Conference Networking” or “Event-Based Contact.” For an SMS-based plain text message, the message constructor may include context as a narrative paragraph such as “Alex wants to connect. You met at Tech Summit 2024, AI Ethics Panel, on March 15 at 3:15pm.” The inclusion of this contextual provenance in the message construction dramatically reduces ambiguity for the destination user, who would otherwise receive a first-contact message from an unknown name without any indication of where the interaction originated. The provenance helps the destination user recall the encounter, assess the legitimacy of the contact attempt, and decide whether to accept, decline, or defer the request. The arrow from contextual provenance capture 1406 to message construction 1408 indicates that captured context directly informs the content and presentation of first-contact communications.

Trust scoring 1409 represents the use of contextual provenance as an input to trust and safety assessments. The AI mediation engine and safety services evaluate context when calculating trust scores for first-contact attempts. Conference contexts with verified organizers and moderated environments contribute positively to trust scores, reflecting the higher likelihood that contacts initiated at professional events are legitimate networking rather than spam or inappropriate approaches. Nightlife venue contexts may result in neutral or slightly negative trust modifiers, triggering enhanced safety screening and more conservative approval defaults to protect destination users in environments where inappropriate contact attempts are more common. Campus contexts with institutional verification contribute positively to trust scores while also enabling affiliation-based matching that increases trust when shared community membership is detected. Digital media contexts are evaluated based on the verification status of the creator or organization, the audience scope, and the campaign metadata, with verified creators and focused campaigns receiving higher trust scores than unverified or mass-distribution contexts. The trust scoring process may also consider temporal factors such as whether the activation occurred during an active event or significantly after the event concluded, with contemporaneous activations receiving higher trust scores. The arrow from contextual provenance capture 1406 to trust scoring 1409 indicates that context influences the assessed safety and legitimacy of contact attempts, enabling the system to apply context-appropriate trust thresholds and safety measures.

Analytics and relationship intelligence 1410 represents the use of contextual provenance for platform-wide analysis, reporting, and optimization. Analytics engines consume contextual provenance to generate insights including conversion rates by venue or event type showing which contexts produce the highest acceptance rates and most successful networking outcomes, venue effectiveness metrics enabling event organizers and venue operators to understand how their spaces facilitate connections, protocol performance by context revealing whether certain contexts correlate with higher or lower enhanced protocol success rates, time-of-day and day-of-week patterns showing when activations are most frequent and most likely to result in accepted connections, geographic and demographic patterns identifying which locations and user segments engage most actively with context-bound activation assets, and relationship development patterns tracking how relationships initiated in different contexts evolve over time in terms of interaction frequency, privacy-release rate, and long-term persistence. Relationship intelligence systems use contextual provenance to support queries such as “show me all contacts from this event,” “how did I meet this person,” or “which venues have produced my most valuable connections.” The analytics and relationship intelligence derived from contextual provenance enable continuous platform improvement, inform venue and event operator decision-making, and provide users with actionable insights about their networking patterns and relationship origins. The arrow from contextual provenance capture 1406 to analytics and relationship intelligence 1410 indicates that captured context feeds ongoing learning and optimization processes.

The overall system architecture illustrated in FIG. 14 demonstrates how context-bound activation assets preserve WHERE, WHEN, and HOW users met, transforming what would otherwise be anonymous or low-context contact exchanges into rich, provenance-supported, and trust-informed social communication initiations. By systematically capturing, binding, and utilizing contextual provenance throughout the communication lifecycle, the disclosed platform enables destination users to make better-informed decisions about first-contact requests, enables trust and safety systems to apply context-appropriate safeguards, enables message construction to provide clarity and recall support, and enables analytics to drive continuous improvement of the networking experience across diverse social environments.

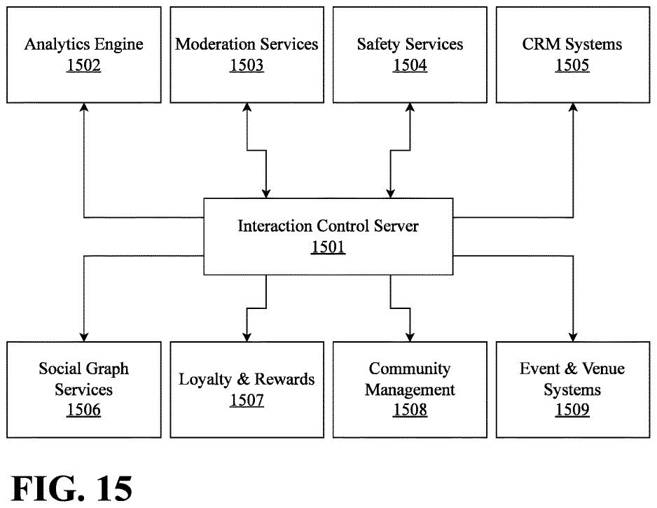

FIG. 15 is a block diagram illustrating downstream integrations including analytics, moderation, customer relationship management, loyalty, safety services, and social graph services. The diagram shows how the interaction control server serves as the central control plane for identity-linked social communication initiation while feeding structured relationship, interaction, and provenance data to specialized external systems that provide analytics, safety enforcement, business intelligence, and community management capabilities, demonstrating the platform's role as an integration hub that maintains communication control while enabling rich downstream processing and analysis.

At the center of the diagram is the interaction control server 1501, which represents the core platform component responsible for managing socially initiated communications. The interaction control server 1501 comprises the persistent identity management service that maintains phone-number-anchored user profiles with accumulated interaction history and relationship states, the permission state manager that enforces privacy and consent rules governing first-contact communications, the channel eligibility service that determines appropriate protocols for message delivery, the capability-aware message constructor that generates protocol-adapted introduction artifacts, the session continuity manager that preserves thread identity across protocol transitions and time periods, and the AI mediation engine that performs safety screening, message enhancement, trust scoring, and communication optimization. The interaction control server 1501 processes all activation events, constructs and delivers all first-contact communications, manages all relay sessions and approval workflows, maintains all session records and relationship-state objects, and serves as the authoritative source of truth for user identities, permissions, and communication states. The interaction control server 1501 integrates with downstream systems by exposing structured data through APIs, webhooks, message queues, or batch exports, enabling external platforms to consume relationship and interaction intelligence while the interaction control server 1501 retains operational control over communication flows.

The analytics engine 1502 consumes event streams and data exports from the interaction control server 1501 to generate insights, metrics, and reports about platform usage, networking patterns, and system performance. The analytics engine 1502 processes data including activation events with contextual provenance showing when and where users encountered activation assets, first-contact delivery and acceptance rates broken down by protocol, context, trust score, and user segments, session lifecycle data tracking how interactions progress from first contact through approval, relay, and potential direct disclosure, protocol performance metrics measuring enhanced protocol success rates, fallback frequencies, and delivery latencies, relationship formation and maturation patterns showing how quickly and under what conditions relationships transition through different privacy and trust states, venue and event effectiveness metrics enabling organizers to understand networking outcomes, user behavior patterns identifying peak usage times, typical interaction frequencies, and response latencies, and conversion funnels showing where users drop off in the communication initiation process and where friction points exist. The analytics engine 1502 may generate dashboards for platform administrators, reports for venue operators and event organizers, and insights for machine learning models that drive platform optimization. The arrow from the interaction control server 1501 to the analytics engine 1502 indicates a unidirectional data flow where the interaction control server 1501 feeds event streams to the analytics engine 1502 but does not receive control signals back, reflecting the analytics engine's role as a passive consumer of telemetry rather than an active participant in communication mediation.

The moderation services 1503 interact bidirectionally with the interaction control server 1501 to enforce safety policies, respond to user reports, and take action on policy violations. The moderation services 1503 receive flags and reports from the interaction control server 1501 including AI-generated safety flags produced during the screening process illustrated in FIG. 11, user-submitted reports where destination users flag first-contact attempts as spam, abuse, harassment, or inappropriate, policy violation detections where automated systems identify prohibited content, fraudulent patterns, or terms of service violations, and escalation requests where the AI mediation engine encounters ambiguous cases requiring human moderator review. The moderation services 1503 process these flags through human moderation teams, automated decision engines, or hybrid workflows, and return actions to the interaction control server 1501 including block directives instructing the platform to prevent a specific user from making further contact attempts, quarantine directives holding messages or interactions for further review, permission adjustments modifying user permission states in response to violations, trust score adjustments updating trust calculations based on confirmed violations or false positives, and policy enforcement records documenting actions taken for audit and compliance purposes. The bidirectional arrows between the interaction control server 1501 and moderation services 1503 indicate that moderation is an active control loop where the interaction control server 1501 surfaces issues and the moderation services 1503 directs enforcement actions that immediately affect communication handling.

The safety services 1504 interact bidirectionally with the interaction control server 1501 to provide specialized fraud detection, identity verification, risk assessment, and trust scoring capabilities. The safety services 1504 receive queries and data from the interaction control server 1501 including real-time trust scoring requests during first-contact processing where the safety services 1504 are asked to assess the risk level of a specific interaction event, identity verification requests where users or contexts require validation against external identity services or document verification systems, fraud detection requests where patterns across multiple interactions or users suggest coordinated abuse or account compromise, device and network fingerprinting data enabling detection of suspicious patterns such as multiple accounts operating from the same device or unusual geographic access patterns, and historical behavior data allowing the safety services 1504 to build risk models based on accumulated user activity across the platform. The safety services 1504 return assessments and directives to the interaction control server 1501 including trust scores indicating the assessed legitimacy and safety of interactions, risk classifications such as low risk, medium risk, high risk, or confirmed fraud, block or quarantine directives when threats are detected, verification status confirmations when identity checks pass or fail, and score explanations providing interpretable signals about why specific risk assessments were made. The bidirectional arrows between the interaction control server 1501 and safety services 1504 indicate that safety is an integral part of the communication flow where real-time assessments directly influence whether and how communications proceed.

The CRM systems 1505 consume relationship and interaction data from the interaction control server 1501 to provide customer relationship management, sales pipeline tracking, networking analytics, and contact management capabilities. The CRM systems 1505 receive data feeds including relationship-state objects documenting when users connected, how relationships have progressed through different stages, and what communication modes are currently active, interaction timelines showing the complete history of communications between user pairs including first contact, follow-ups, protocol transitions, and privacy releases, contact histories enabling users or organizations to maintain records of networking outcomes and relationship development, customer journey mapping where organizations track how prospects or customers move through relationship stages, and provenance data documenting the events, venues, or campaigns through which relationships originated. The CRM systems 1505 may be general-purpose enterprise CRM platforms, specialized networking or community management systems, sales enablement tools, or custom relationship tracking applications built on the platform's data exports. The unidirectional arrow from the interaction control server 1501 to CRM systems 1505 indicates that CRM is a downstream consumer of relationship intelligence without direct influence over communication flows, though CRM-derived insights may inform user behavior or platform strategy changes that indirectly affect the interaction control server 1501.

The social graph services 1506 consume connection and relationship data from the interaction control server 1501 to map social networks, identify mutual contacts, analyze community structures, and support discovery and recommendation features. The social graph services 1506 receive data including connection events documenting when new relationships form, creating edges in the social graph between user nodes, mutual contact identification enabling the system to recognize when two users have connections to the same third parties, network analysis data supporting queries such as “who do we both know” or “how am I connected to this person,” community detection signals identifying clusters of users who frequently interact within the same venues, events, or contexts, and relationship strength indicators based on interaction frequency, protocol progression, and relationship duration. The social graph services 1506 may power features including mutual contact displays showing shared connections when evaluating first-contact requests, friend-of-friend recommendations suggesting networking opportunities, community identification grouping users into affinity-based or context-based communities, network analysis revealing influential connectors or isolated users, and privacy controls enabling users to limit visibility or connection requests based on network distance. The unidirectional arrow from the interaction control server 1501 to social graph services 1506 indicates that graph construction and analysis are passive processes that do not directly influence communication flows, though graph-derived insights such as mutual contact detection may enhance trust scoring or message construction within the interaction control server 1501.

The loyalty and rewards systems 1507 consume engagement data from the interaction control server 1501 to credit users for networking activities, track referrals, implement incentive programs, and gamify social engagement. The loyalty and rewards systems 1507 receive data including engagement points earned when users successfully establish new connections, activate assets, or respond to first-contact requests, referral tracking showing when users introduce others to the platform or facilitate connections between their contacts, incentive program participation where specific contexts such as events or venues offer rewards for networking activity, gamification metrics such as connection counts, response rates, or diversity of contexts engaged, and milestone achievements such as reaching certain relationship counts or successfully networking across multiple venues. The loyalty and rewards systems 1507 may implement points programs, achievement badges, leaderboards, sweepstakes, or direct incentives that encourage platform engagement and reward positive networking behavior. The unidirectional arrow from the interaction control server 1501 to loyalty and rewards 1507 indicates that loyalty programs are downstream consumers that do not control communication flows but may influence user motivation and engagement levels.

The community management systems 1508 consume aggregated data from the interaction control server 1501 to provide venue operators, event organizers, group administrators, and community leaders with tools for managing and optimizing networking environments. The community management systems 1508 receive data including venue and event analytics showing activation frequencies, acceptance rates, and networking outcomes for specific contexts, activity dashboards displaying real-time or near-real-time networking activity during events, attendee engagement metrics enabling organizers to understand which participants are actively networking, policy compliance reports documenting moderation actions or safety incidents within specific communities, and benchmarking data comparing networking performance across similar venues or events. The community management systems 1508 may enable venue operators to adjust activation asset configurations, view participant interaction patterns, respond to safety concerns, and optimize physical space layouts or event programming based on networking data. The unidirectional arrow from the interaction control server 1501 to community management 1508 indicates that community systems are reporting and analytics consumers without direct control over individual communications, though community administrators may configure context-specific permission defaults or moderation policies that affect how the interaction control server 1501 handles activations within their contexts.

The event and venue systems 1509 consume activation and outcome data from the interaction control server 1501 to measure return on investment, optimize event programming, track attendee networking success, and support badge scanning and registration integrations. The event and venue systems 1509 receive data including attendee analytics showing which registered participants activated assets, were contacted by others, or successfully established connections, networking metrics measuring how many connections formed during an event, what the average connection rate per attendee was, and what percentage of contacts were accepted versus declined, badge scan tracking documenting when and where activation assets were scanned within event venues, enabling organizers to understand traffic flow and popular networking zones, ROI measurement quantifying the networking value delivered by events through connection counts, relationship formations, and post-event engagement, and integration data supporting real-time bidirectional synchronization between event registration systems and the platform's identity management. The event and venue systems 1509 may be event management platforms, conference software, badge printing systems, or venue booking platforms that integrate with the disclosed platform to provide networking capabilities as part of their core offering. The unidirectional arrow from the interaction control server 1501 to event and venue systems 1509 indicates that event systems are primarily data consumers, though registration integrations may flow bidirectionally where event systems provide attendee rosters that prepopulate identity profiles within the interaction control server 1501.

The overall architecture illustrated in FIG. 15 demonstrates that the interaction control server 1501 functions as a hub-and-spoke integration model where the interaction control server 1501 maintains authoritative control over communication flows, identity management, and relationship state while exposing rich structured data to specialized downstream systems that provide analytics, safety enforcement, business intelligence, community management, and other value-added services. This architecture enables the platform to remain focused on its core competency of privacy-controlled, context-aware, identity-linked social communication initiation while leveraging best-of-breed external systems for specialized processing, analysis, and integration. The unidirectional arrows to analytics, CRM, social graph, loyalty, community management, and event systems indicate that these are passive consumers of platform intelligence, while the bidirectional arrows to moderation and safety services indicate that these systems actively participate in the control loop, directly influencing whether and how communications proceed based on real-time safety and policy assessments. This integration architecture supports scalability, modularity, and ecosystem development while preserving the interaction control server's role as the single source of truth and operational control point for socially initiated communications.

### Exemplary Computing Environment

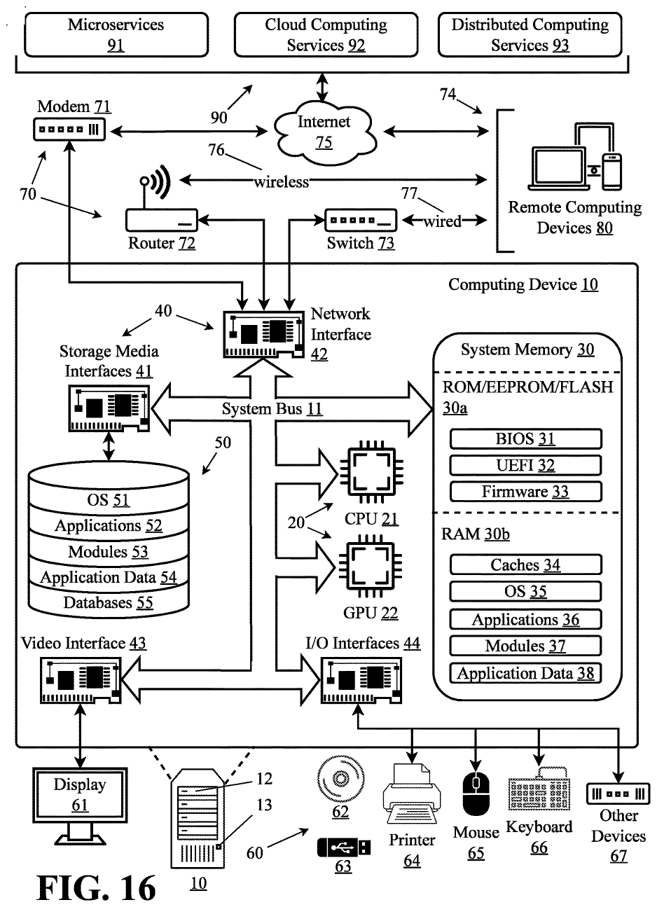

FIG. 16 illustrates an exemplary computing environment on which an embodiment described herein may be implemented, in full or in part. This exemplary computing environment describes computer-related components and processes supporting enabling disclosure of computer-implemented embodiments. Inclusion in this exemplary computing environment of well-known processes and computer components, if any, is not a suggestion or admission that any embodiment is no more than an aggregation of such processes or components. Rather, implementation of an embodiment using processes and components described in this exemplary computing environment will involve programming or configuration of such processes and components resulting in a machine specially programmed or configured for such implementation. The exemplary computing environment described herein is only one example of such an environment and other configurations of the components and processes are possible, including other relationships between and among components, and/or absence of some processes or components described. Further, the exemplary computing environment described herein is not intended to suggest any limitation as to the scope of use or functionality of any embodiment implemented, in whole or in part, on components or processes described herein.

The exemplary computing environment described herein comprises a computing device 10 (further comprising a system bus 11, one or more processors 20, a system memory 30, one or more interfaces 40, one or more non-volatile data storage devices 50), external peripherals and accessories 60, external communication devices 70, remote computing devices 80, and cloud-based services 90.

System bus 11 couples the various system components, coordinating operation of and data transmission between those various system components. System bus 11 represents one or more of any type or combination of types of wired or wireless bus structures including, but not limited to, memory busses or memory controllers, point-to-point connections, switching fabrics, peripheral busses, accelerated graphics ports, and local busses using any of a variety of bus architectures. By way of example, such architectures include, but are not limited to, Industry Standard Architecture (ISA) busses, Micro Channel Architecture (MCA) busses, Enhanced ISA (EISA) busses, Video Electronics Standards Association (VESA) local busses, a Peripheral Component Interconnects (PCI) busses also known as a Mezzanine busses, or any selection of, or combination of, such busses. Depending on the specific physical implementation, one or more of the processors 20, system memory 30 and other components of the computing device 10 can be physically co-located or integrated into a single physical component, such as on a single chip. In such a case, some or all of system bus 11 can be electrical pathways within a single chip structure.

Computing device may further comprise externally-accessible data input and storage devices 12 such as compact disc read-only memory (CD-ROM) drives, digital versatile discs (DVD), or other optical disc storage for reading and/or writing optical discs 62; magnetic cassettes, magnetic tape, magnetic disk storage, or other magnetic storage devices; or any other medium which can be used to store the desired content and which can be accessed by the computing device 10. Computing device may further comprise externally-accessible data ports or connections 12 such as serial ports, parallel ports, universal serial bus (USB) ports, and infrared ports and/or transmitter/receivers. Computing device may further comprise hardware for wireless communication with external devices such as IEEE 1394 (“Firewire”) interfaces, IEEE 802.11 wireless interfaces, BLUETOOTH® wireless interfaces, and so forth. Such ports and interfaces may be used to connect any number of external peripherals and accessories 60 such as visual displays, monitors, and touch-sensitive screens 61, USB solid state memory data storage drives (commonly known as “flash drives” or “thumb drives”) 63, printers 64, pointers and manipulators such as mice 65, keyboards 66, and other devices 67 such as joysticks and gaming pads, touchpads, additional displays and monitors, and external hard drives (whether solid state or disc-based), microphones, speakers, cameras, and optical scanners.

Processors 20 are logic circuitry capable of receiving programming instructions and processing (or executing) those instructions to perform computer operations such as retrieving data, storing data, and performing mathematical calculations. Processors 20 are not limited by the materials from which they are formed or the processing mechanisms employed therein, but are typically comprised of semiconductor materials into which many transistors are formed together into logic gates on a chip (i.e., an integrated circuit or IC). The term processor includes any device capable of receiving and processing instructions including, but not limited to, processors operating on the basis of quantum computing, optical computing, mechanical computing (e.g., using nanotechnology entities to transfer data), and so forth. Depending on configuration, computing device 10 may comprise more than one processor. For example, computing device 10 may comprise one or more central processing units (CPUs) 21, each of which itself has multiple processors or multiple processing cores, each capable of independently or semi-independently processing programming instructions based on technologies like complex instruction set computer (CISC) or reduced instruction set computer (RISC). Further, computing device 10 may comprise one or more specialized processors such as a graphics processing unit (GPU) 22 configured to accelerate processing of computer graphics and images via a large array of specialized processing cores arranged in parallel. Further computing device 10 may be comprised of one or more specialized processes such as Intelligent Processing Units, field-programmable gate arrays or application-specific integrated circuits for specific tasks or types of tasks. The term processor may further include: neural processing units (NPUs) or neural computing units optimized for machine learning and artificial intelligence workloads using specialized architectures and data paths; tensor processing units (TPUs) designed to efficiently perform matrix multiplication and convolution operations used heavily in neural networks and deep learning applications; application-specific integrated circuits (ASICs) implementing custom logic for domain-specific tasks; application-specific instruction set processors (ASIPs) with instruction sets tailored for particular applications; field-programmable gate arrays (FPGAs) providing reconfigurable logic fabric that can be customized for specific processing tasks; processors operating on emerging computing paradigms such as quantum computing, optical computing, mechanical computing (e.g., using nanotechnology entities to transfer data), and so forth. Depending on configuration, computing device 10 may comprise one or more of any of the above types of processors in order to efficiently handle a variety of general purpose and specialized computing tasks. The specific processor configuration may be selected based on performance, power, cost, or other design constraints relevant to the intended application of computing device 10.

System memory 30 is processor-accessible data storage in the form of volatile and/or nonvolatile memory. System memory 30 may be either or both of two types: non-volatile memory and volatile memory. Non-volatile memory 30a is not erased when power to the memory is removed, and includes memory types such as read only memory (ROM), electronically-erasable programmable memory (EEPROM), and rewritable solid state memory (commonly known as “flash memory”). Non-volatile memory 30a is typically used for long-term storage of a basic input/output system (BIOS) 31, containing the basic instructions, typically loaded during computer startup, for transfer of information between components within computing device, or a unified extensible firmware interface (UEFI), which is a modern replacement for BIOS that supports larger hard drives, faster boot times, more security features, and provides native support for graphics and mouse cursors. Non-volatile memory 30a may also be used to store firmware comprising a complete operating system 35 and applications 36 for operating computer-controlled devices. The firmware approach is often used for purpose-specific computer-controlled devices such as appliances and Internet-of-Things (IoT) devices where processing power and data storage space is limited. Volatile memory 30b is erased when power to the memory is removed and is typically used for short-term storage of data for processing. Volatile memory 30b includes memory types such as random-access memory (RAM), and is normally the primary operating memory into which the operating system 35, applications 36, program modules 37, and application data 38 are loaded for execution by processors 20. Volatile memory 30b is generally faster than non-volatile memory 30a due to its electrical characteristics and is directly accessible to processors 20 for processing of instructions and data storage and retrieval. Volatile memory 30b may comprise one or more smaller cache memories which operate at a higher clock speed and are typically placed on the same IC as the processors to improve performance.

There are several types of computer memory, each with its own characteristics and use cases. System memory 30 may be configured in one or more of the several types described herein, including high bandwidth memory (HBM) and advanced packaging technologies like chip-on-wafer-on-substrate (CoWoS). Static random access memory (SRAM) provides fast, low-latency memory used for cache memory in processors, but is more expensive and consumes more power compared to dynamic random access memory (DRAM). SRAM retains data as long as power is supplied. DRAM is the main memory in most computer systems and is slower than SRAM but cheaper and more dense. DRAM requires periodic refresh to retain data. NAND flash is a type of non-volatile memory used for storage in solid state drives (SSDs) and mobile devices and provides high density and lower cost per bit compared to DRAM with the trade-off of slower write speeds and limited write endurance. HBM is an emerging memory technology that provides high bandwidth and low power consumption which stacks multiple DRAM dies vertically, connected by through-silicon vias (TSVs). HBM offers much higher bandwidth (up to 1 TB/s) compared to traditional DRAM and may be used in high-performance graphics cards, AI accelerators, and edge computing devices. Advanced packaging and CoWoS are technologies that enable the integration of multiple chips or dies into a single package. CoWoS is a 2.5D packaging technology that interconnects multiple dies side-by-side on a silicon interposer and allows for higher bandwidth, lower latency, and reduced power consumption compared to traditional PCB-based packaging. This technology enables the integration of heterogeneous dies (e.g., CPU, GPU, HBM) in a single package and may be used in high-performance computing, AI accelerators, and edge computing devices.

Interfaces 40 may include, but are not limited to, storage media interfaces 41, network interfaces 42, display interfaces 43, and input/output interfaces 44. Storage media interface 41 provides the necessary hardware interface for loading data from non-volatile data storage devices 50 into system memory 30 and storage data from system memory 30 to non-volatile data storage device 50. Network interface 42 provides the necessary hardware interface for computing device 10to communicate with remote computing devices 80 and cloud-based services 90 via one or more external communication devices 70. Display interface 43 allows for connection of displays 61, monitors, touchscreens, and other visual input/output devices. Display interface 43 may include a graphics card for processing graphics-intensive calculations and for handling demanding display requirements. Typically, a graphics card includes a graphics processing unit (GPU) and video RAM (VRAM) to accelerate display of graphics. In some high-performance computing systems, multiple GPUs may be connected using NVLink bridges, which provide high-bandwidth, low-latency interconnects between GPUs. NVLink bridges enable faster data transfer between GPUs, allowing for more efficient parallel processing and improved performance in applications such as machine learning, scientific simulations, and graphics rendering. One or more input/output (I/O) interfaces 44 provide the necessary support for communications between computing device 10 and any external peripherals and accessories 60. For wireless communications, the necessary radio-frequency hardware and firmware may be connected to I/O interface 44 or may be integrated into I/O interface 44. Network interface 42 may support various communication standards and protocols, such as Ethernet and Small Form-Factor Pluggable (SFP). Ethernet is a widely used wired networking technology that enables local area network (LAN) communication. Ethernet interfaces typically use RJ45 connectors and support data rates ranging from 10 Mbps to 100 Gbps, with common speeds being 100 Mbps, 1 Gbps, 10 Gbps, 25 Gbps, 40 Gbps, and 100 Gbps. Ethernet is known for its reliability, low latency, and cost-effectiveness, making it a popular choice for home, office, and data center networks. SFP is a compact, hot-pluggable transceiver used for both telecommunication and data communications applications. SFP interfaces provide a modular and flexible solution for connecting network devices, such as switches and routers, to fiber optic or copper networking cables. SFP transceivers support various data rates, ranging from 100 Mbps to 100 Gbps, and can be easily replaced or upgraded without the need to replace the entire network interface card. This modularity allows for network scalability and adaptability to different network requirements and fiber types, such as single-mode or multi-mode fiber.

Non-volatile data storage devices 50 are typically used for long-term storage of data. Data on non-volatile data storage devices 50 is not erased when power to the non-volatile data storage devices 50 is removed. Non-volatile data storage devices 50 may be implemented using any technology for non-volatile storage of content including, but not limited to, CD-ROM drives, digital versatile discs (DVD), or other optical disc storage; magnetic cassettes, magnetic tape, magnetic disc storage, or other magnetic storage devices; solid state memory technologies such as EEPROM or flash memory; or other memory technology or any other medium which can be used to store data without requiring power to retain the data after it is written. Non-volatile data storage devices 50 may be non-removable from computing device 10 as in the case of internal hard drives, removable from computing device 10 as in the case of external USB hard drives, or a combination thereof, but computing device will typically comprise one or more internal, non-removable hard drives using either magnetic disc or solid state memory technology. Non-volatile data storage devices 50 may be implemented using various technologies, including hard disk drives (HDDs) and solid-state drives (SSDs). HDDs use spinning magnetic platters and read/write heads to store and retrieve data, while SSDs use NAND flash memory. SSDs offer faster read/write speeds, lower latency, and better durability due to the lack of moving parts, while HDDs typically provide higher storage capacities and lower cost per gigabyte. NAND flash memory comes in different types, such as Single-Level Cell (SLC), Multi-Level Cell (MLC), Triple-Level Cell (TLC), and Quad-Level Cell (QLC), each with trade-offs between performance, endurance, and cost. Storage devices connect to the computing device 10 through various interfaces, such as SATA, NVMe, and PCIe. SATA is the traditional interface for HDDs and SATA SSDs, while NVMe (Non-Volatile Memory Express) is a newer, high-performance protocol designed for SSDs connected via PCIe. PCIe SSDs offer the highest performance due to the direct connection to the PCIe bus, bypassing the limitations of the SATA interface. Other storage form factors include M.2 SSDs, which are compact storage devices that connect directly to the motherboard using the M.2 slot, supporting both SATA and NVMe interfaces. Additionally, technologies like Intel Optane memory combine 3D XPoint technology with NAND flash to provide high-performance storage and caching solutions. Non-volatile data storage devices 50 may be non-removable from computing device 10, as in the case of internal hard drives, removable from computing device 10, as in the case of external USB hard drives, or a combination thereof. However, computing devices will typically comprise one or more internal, non-removable hard drives using either magnetic disc or solid-state memory technology. Non-volatile data storage devices 50 may store any type of data including, but not limited to, an operating system 51 for providing low-level and mid-level functionality of computing device 10, applications 52 for providing high-level functionality of computing device 10, program modules 53 such as containerized programs or applications, or other modular content or modular programming, application data 54, and databases 55 such as relational databases, non-relational databases, object oriented databases, NoSQL databases, vector databases, knowledge graph databases, key-value databases, document oriented data stores, and graph databases.

Applications (also known as computer software or software applications) are sets of programming instructions designed to perform specific tasks or provide specific functionality on a computer or other computing devices. Applications are typically written in high-level programming languages such as C, C++, Scala, Erlang, GoLang, Java, Scala, Rust, and Python, which are then either interpreted at runtime or compiled into low-level, binary, processor-executable instructions operable on processors 20. Applications may be containerized so that they can be run on any computer hardware running any known operating system. Containerization of computer software is a method of packaging and deploying applications along with their operating system dependencies into self-contained, isolated units known as containers. Containers provide a lightweight and consistent runtime environment that allows applications to run reliably across different computing environments, such as development, testing, and production systems facilitated by specifications such as containerd.

The memories and non-volatile data storage devices described herein do not include communication media. Communication media are means of transmission of information such as modulated electromagnetic waves or modulated data signals configured to transmit, not store, information. By way of example, and not limitation, communication media includes wired communications such as sound signals transmitted to a speaker via a speaker wire, and wireless communications such as acoustic waves, radio frequency (RF) transmissions, infrared emissions, and other wireless media.

External communication devices 70 are devices that facilitate communications between computing device and either remote computing devices 80, or cloud-based services 90, or both. External communication devices 70 include, but are not limited to, data modems 71 which facilitate data transmission between computing device and the Internet 75 via a common carrier such as a telephone company or internet service provider (ISP), routers 72 which facilitate data transmission between computing device and other devices, and switches 73 which provide direct data communications between devices on a network or optical transmitters (e.g., lasers). Here, modem 71 is shown connecting computing device 10 to both remote computing devices 80 and cloud-based services 90 via the Internet 75. While modem 71, router 72, and switch 73 are shown here as being connected to network interface 42, many different network configurations using external communication devices 70 are possible. Using external communication devices 70, networks may be configured as local area networks (LANs) for a single location, building, or campus, wide area networks (WANs) comprising data networks that extend over a larger geographical area, and virtual private networks (VPNs) which can be of any size but connect computers via encrypted communications over public networks such as the Internet 75. As just one exemplary network configuration, network interface 42 may be connected to switch 73 which is connected to router 72 which is connected to modem 71 which provides access for computing device 10 to the Internet 75. Further, any combination of wired 77 or wireless 76 communications between and among computing device 10, external communication devices 70, remote computing devices 80, and cloud-based services 90 may be used. Remote computing devices 80, for example, may communicate with computing device through a variety of communication channels 74 such as through switch 73 via a wired 77 connection, through router 72 via a wireless connection 76, or through modem 71 via the Internet 75. Furthermore, while not shown here, other hardware that is specifically designed for servers or networking functions may be employed. For example, secure socket layer (SSL) acceleration cards can be used to offload SSL encryption computations, and transmission control protocol/internet protocol (TCP/IP) offload hardware and/or packet classifiers on network interfaces 42 may be installed and used at server devices or intermediate networking equipment (e.g., for deep packet inspection).

In a networked environment, certain components of computing device 10 may be fully or partially implemented on remote computing devices 80 or cloud-based services 90. Data stored in non-volatile data storage device 50 may be received from, shared with, duplicated on, or offloaded to a non-volatile data storage device on one or more remote computing devices 80 or in a cloud computing service 92. Processing by processors 20 may be received from, shared with, duplicated on, or offloaded to processors of one or more remote computing devices 80 or in a distributed computing service 93. By way of example, data may reside on a cloud computing service 92, but may be usable or otherwise accessible for use by computing device 10. Also, certain processing subtasks may be sent to a microservice 91 for processing with the result being transmitted to computing device 10 for incorporation into a larger processing task. Also, while components and processes of the exemplary computing environment are illustrated herein as discrete units (e.g., OS 51 being stored on non-volatile data storage device 51 and loaded into system memory 35 for use) such processes and components may reside or be processed at various times in different components of computing device 10, remote computing devices 80, and/or cloud-based services 90. Also, certain processing subtasks may be sent to a microservice 91 for processing with the result being transmitted to computing device 10 for incorporation into a larger processing task. Infrastructure as Code (IaaC) tools like Terraform can be used to manage and provision computing resources across multiple cloud providers or hyperscalers. This allows for workload balancing based on factors such as cost, performance, and availability. For example, Terraform can be used to automatically provision and scale resources on AWS spot instances during periods of high demand, such as for surge rendering tasks, to take advantage of lower costs while maintaining the required performance levels. In the context of rendering, tools like Blender can be used for object rendering of specific elements, such as a car, bike, or house. These elements can be approximated and roughed in using techniques like bounding box approximation or low-poly modeling to reduce the computational resources required for initial rendering passes. The rendered elements can then be integrated into the larger scene or environment as needed, with the option to replace the approximated elements with higher-fidelity models as the rendering process progresses.

In an implementation, the disclosed systems and methods may utilize, at least in part, containerization techniques to execute one or more processes and/or steps disclosed herein. Containerization is a lightweight and efficient virtualization technique that allows you to package and run applications and their dependencies in isolated environments called containers. One of the most popular containerization platforms is containerd, which is widely used in software development and deployment. Containerization, particularly with open-source technologies like containerd and container orchestration systems like Kubernetes, is a common approach for deploying and managing applications. Containers are created from images, which are lightweight, standalone, and executable packages that include application code, libraries, dependencies, and runtime. Images are often built from a containerfile or similar, which contains instructions for assembling the image. Containerfiles are configuration files that specify how to build a container image. Systems like Kubernetes natively support containerd as a container runtime. They include commands for installing dependencies, copying files, setting environment variables, and defining runtime configurations. Container images can be stored in repositories, which can be public or private. Organizations often set up private registries for security and version control using tools such as Harbor, JFrog Artifactory and Bintray, GitLab Container Registry, or other container registries. Containers can communicate with each other and the external world through networking. Containerd provides a default network namespace, but can be used with custom network plugins. Containers within the same network can communicate using container names or IP addresses.

Remote computing devices 80 are any computing devices not part of computing device 10. Remote computing devices 80 include, but are not limited to, personal computers, server computers, thin clients, thick clients, personal digital assistants (PDAs), mobile telephones, watches, tablet computers, laptop computers, multiprocessor systems, microprocessor based systems, set-top boxes, programmable consumer electronics, video game machines, game consoles, portable or handheld gaming units, network terminals, desktop personal computers (PCs), minicomputers, mainframe computers, network nodes, virtual reality or augmented reality devices and wearables, and distributed or multi-processing computing environments. While remote computing devices 80 are shown for clarity as being separate from cloud-based services 90, cloud-based services 90 are implemented on collections of networked remote computing devices 80.

Cloud-based services 90 are Internet-accessible services implemented on collections of networked remote computing devices 80. Cloud-based services are typically accessed via application programming interfaces (APIs) which are software interfaces which provide access to computing services within the cloud-based service via API calls, which are pre-defined protocols for requesting a computing service and receiving the results of that computing service. While cloud-based services may comprise any type of computer processing or storage, three common categories of cloud-based services 90 are serverless logic apps, microservices 91, cloud computing services 92, and distributed computing services 93.

Microservices 91 are collections of small, loosely coupled, and independently deployable computing services. Each microservice represents a specific computing functionality and runs as a separate process or container. Microservices promote the decomposition of complex applications into smaller, manageable services that can be developed, deployed, and scaled independently. These services communicate with each other through well-defined application programming interfaces (APIs), typically using lightweight protocols like HTTP, protobuffers, gRPC or message queues such as Kafka. Microservices 91 can be combined to perform more complex or distributed processing tasks. In an embodiment, Kubernetes clusters with containerized resources are used for operational packaging of system.

Cloud computing services 92 are delivery of computing resources and services over the Internet 75 from a remote location. Cloud computing services 92 provide additional computer hardware and storage on as-needed or subscription basis. Cloud computing services 92 can provide large amounts of scalable data storage, access to sophisticated software and powerful server-based processing, or entire computing infrastructures and platforms. For example, cloud computing services can provide virtualized computing resources such as virtual machines, storage, and networks, platforms for developing, running, and managing applications without the complexity of infrastructure management, and complete software applications over public or private networks or the Internet on a subscription or alternative licensing basis, or consumption or ad-hoc marketplace basis, or combination thereof.

Distributed computing services 93 provide large-scale processing using multiple interconnected computers or nodes to solve computational problems or perform tasks collectively. In distributed computing, the processing and storage capabilities of multiple machines are leveraged to work together as a unified system. Distributed computing services are designed to address problems that cannot be efficiently solved by a single computer or that require large-scale computational power or support for highly dynamic compute, transport or storage resource variance or uncertainty over time requiring scaling up and down of constituent system resources. These services enable parallel processing, fault tolerance, and scalability by distributing tasks across multiple nodes.

Although described above as a physical device, computing device 10 can be a virtual computing device, in which case the functionality of the physical components herein described, such as processors 20, system memory 30, network interfaces 40, NVLink or other GPU-to-GPU high bandwidth communications links and other like components can be provided by computer-executable instructions. Such computer-executable instructions can execute on a single physical computing device, or can be distributed across multiple physical computing devices, including being distributed across multiple physical computing devices in a dynamic manner such that the specific, physical computing devices hosting such computer-executable instructions can dynamically change over time depending upon need and availability. In the situation where computing device 10 is a virtualized device, the underlying physical computing devices hosting such a virtualized computing device can, themselves, comprise physical components analogous to those described above, and operating in a like manner. Furthermore, virtual computing devices can be utilized in multiple layers with one virtual computing device executing within the construct of another virtual computing device. Thus, computing device 10 may be either a physical computing device or a virtualized computing device within which computer-executable instructions can be executed in a manner consistent with their execution by a physical computing device. Similarly, terms referring to physical components of the computing device, as utilized herein, mean either those physical components or virtualizations thereof performing the same or equivalent functions.

The skilled person will be aware of a range of possible modifications of the various aspects described above. Accordingly, the present invention is defined by the claims and their equivalents.

What is claimed is:

1. A system for identity-linked social communication initiation using activation assets, the system comprising:
a digital activation asset associated with a destination-user identity profile, the digital activation asset comprising a machine-readable or machine-activatable object configured to be activated by an initiating user device;
an interaction control server communicatively coupled to the initiating user device and configured to:
receive an interaction event resulting from activation of the digital activation asset by the initiating user device, the interaction event comprising at least a destination-user identifier and contextual metadata;
resolve the destination-user identifier to the destination-user identity profile, the destination-user identity profile being anchored to a phone number and comprising at least a permission state, interaction history, and relationship-state data;
evaluate the permission state to determine whether communication is permitted and to determine a communication mode selected from a set comprising direct communication, masked relay, and approval-required communication;
determine channel eligibility by evaluating at least device capability, carrier support for multiple communication protocols, and historical protocol success for the destination user;
construct a capability-aware first-contact message adapted to a selected communication protocol and the determined communication mode; and
deliver the capability-aware first-contact message to a destination user device associated with the destination-user identity profile;
wherein the interaction control server is further configured to create or update a relationship-state object linking the initiating user and the destination user when communication is established, the relationship-state object storing at least first-contact provenance, approval state, communication preferences, and protocol transition history.

2. The system of claim 1, wherein the contextual metadata comprises at least one of an event identifier, a venue identifier, a geographic location, a timestamp, and an activation method, and wherein the interaction control server is configured to bind the contextual metadata to a session record and to the relationship-state object, thereby preserving provenance of where and when the initiating user and destination user met.

3. The system of claim 1, wherein the interaction control server comprises an artificial-intelligence mediation engine configured to:
perform safety screening on the interaction event or first-contact message content to detect spam, abuse, fraud, or policy violations;
generate a trust score based on at least the safety screening results, contextual metadata, and initiating-user history;
enhance message content by improving grammar, clarity, or social appropriateness; and
generate response suggestions for presentation to the destination user.

4. The system of claim 1, wherein when the permission state indicates that masked relay is required, the interaction control server is configured to:
create a relay session with a unique session identifier;
assign system-controlled relay addresses for communication between the initiating user device and the destination user device;
mask endpoint identifiers such that the initiating user's phone number is not disclosed to the destination user and the destination user's phone number is not disclosed to the initiating user; and
route all communications between the initiating user and the destination user through the relay session while maintaining session continuity.

5. The system of claim 4, wherein the interaction control server is further configured to evaluate one or more release conditions to determine whether direct contact disclosure should be permitted, the release conditions comprising at least one of: affirmative approval by the destination user, achievement of a trust threshold, elapsed time, mutual verification, and explicit destination-user override.

6. The system of claim 1, wherein the capability-aware first-contact message comprises:
a rich introduction card when the selected communication protocol comprises Rich Communication Service (RCS) and the permission state permits enhanced protocol features, the rich introduction card comprising structured identity information, interactive buttons, contextual provenance, and media content; or
a plain text message when the selected communication protocol comprises Short Message Service (SMS) or Multimedia Messaging Service (MMS), the plain text message comprising numbered reply options, text-based contextual descriptions, and functionally equivalent interaction intent as the rich introduction card.

7. The system of claim 1, wherein the interaction control server further comprises a session continuity manager configured to:
assign a session identifier to the first-contact communication;
detect a delivery failure when the capability-aware first-contact message cannot be delivered via the selected communication protocol;
retrieve session state associated with the session identifier;
select a fallback communication protocol;
regenerate the capability-aware first-contact message adapted to the fallback communication protocol while preserving the session identifier; and
deliver the regenerated message via the fallback communication protocol, thereby maintaining thread identity and context despite protocol transition.

8. The system of claim 1, wherein when the permission state indicates that approval is required, the interaction control server is configured to:
generate an approval request object comprising initiating-user identity information, contextual provenance, an introduction preview, and interactive controls;
deliver the approval request object to the destination user device;
receive a user action selected from accept, decline, and defer;
when the user action is accepted, create a masked relay session and open a communication thread; and
when the user action is declined, send a rejection notification to the initiating user device and prevent establishment of a communication channel.

9. The system of claim 1, wherein the destination-user identity profile further comprises:
device associations tracking devices linked to the destination user's phone number;
social context history recording venues, events, and media sources through which the destination user's activation assets have been deployed;
communication preferences comprising preferred protocols, timing preferences, and response patterns;
trust and safety data comprising trust scores, moderation history, and verification status; and
AI-derived inferences comprising inferred communication preferences and predicted response likelihood.

10. The system of claim 1, wherein the interaction control server is communicatively coupled to one or more downstream integration systems comprising at least one of an analytics engine, a moderation service, a safety service, a customer relationship management system, a social graph service, a loyalty and rewards system, a community management system, and an event and venue system, and wherein the interaction control server is configured to provide structured relationship data, interaction data, and provenance data to the one or more downstream integration systems while maintaining operational control over communication flows.

11. A method for identity-linked social communication initiation using activation assets, the method comprising the steps of:
receiving an interaction event resulting from activation of the digital activation asset by the initiating user device, the interaction event comprising at least a destination-user identifier and contextual metadata, using an interaction control server;
resolving the destination-user identifier to the destination-user identity profile, the destination-user identity profile being anchored to a phone number and comprising at least a permission state, interaction history, and relationship-state data, using an interaction control server;
evaluating the permission state to determine whether communication is permitted and to determine a communication mode selected from a set comprising direct communication, masked relay, and approval-required communication, using an interaction control server;
determining channel eligibility by evaluating at least device capability, carrier support for multiple communication protocols, and historical protocol success for the destination user, using an interaction control server;
constructing a capability-aware first-contact message adapted to a selected communication protocol and the determined communication mode, using an interaction control server;
delivering the capability-aware first-contact message to a destination user device associated with the destination-user identity profile, using an interaction control server;
creating or updating a relationship-state object linking the initiating user and the destination user when communication is established, the relationship-state object storing at least first-contact provenance, approval state, communication preferences, and protocol transition history, using an interaction control server.
